(19) United States
(12) Patent Application Publication
(10) Pub. No.: US 2026/0016618 A1
(43) Pub. Date: Jan. 15, 2026

(54) OPTICAL MEMBER AND METHOD OF PRODUCING OPTICAL MEMBER

(71) Applicant: FUJIFILM CORPORATION, Tokyo (JP)

(72) Inventors: Hiroki TAKAHASHI, Saitama (JP); Tomokazu UMEZAWA, Saitama (JP); Takeshi MINEGISHI, Tochigi (JP)

(21) Appl. No.: 19/332,058

(22) Filed: Sep. 18, 2025

Related U.S. Application Data
(63) Continuation of application No. PCT/JP2024/009419, filed on Mar. 11, 2024.

(30) Foreign Application Priority Data
Mar. 29, 2023 (JP) 2023-054253

(51) Int. Cl. G02B 1/18

(52) U.S. Cl. CPC G02B 1/18

(57) ABSTRACT

Provided are an optical member including an optical substrate having a smooth surface and a silicon oxide film provided on the optical substrate, in which the silicon oxide film has a fine uneven structure on a surface thereof, comprises a water-repellent film containing a fluorine compound on the surface of the fine uneven structure, and a surface of the water-repellent film has an adhesion energy of 0.2 mN/m to 6 mN/m, and a method of producing an optical member.

### CROSS-REFERENCE TO RELATED APPLICATIONS

This application is a continuation of International Application No. PCT/JP2024/009419, filed on Mar. 11, 2024, which claims priority from Japanese Patent Application No. 2023-054253, filed on Mar. 29, 2023. The entire disclosure of each of the above applications is incorporated herein by reference.

### BACKGROUND

### 1. Technical Field

The present disclosure relates to an optical member and a method of producing an optical member.

### 2. Related Art

It is desirable that an optical member used in a camera or the like has a low reflectivity with respect to incident light. In addition, in an optical member provided on a surface exposed to the outside, there is a demand for preventing adhesion of water droplets such as raindrops in order to suppress reflection of raindrops on an image.

JP2020-56866A discloses a glass laminate comprising an antireflection layer consisting of a multilayer film comprising a silicon oxide film on an uneven surface of a glass substrate having an uneven surface on which fine unevenness is formed, and an antifouling layer on a surface of the antireflection layer.

JP2018-198050A discloses a transparent substrate with an antifouling film, which comprises an antiglare layer having, on a surface thereof, unevenness formed by coating the transparent substrate with a binder containing silicon oxide as a main component and baking the binder, and an antifouling layer formed on the antiglare layer.

JP2015-59977A discloses a method of forming fine unevenness on a surface of a transparent base.

### SUMMARY

An object of the present disclosure is to provide an optical member having high water repellency and capable of suppressing the adhesion of water droplets, and a method of producing an optical member.

According to an aspect of the present disclosure, there is provided an optical member comprising: an optical substrate having a smooth surface; and a silicon oxide film provided on the optical substrate, in which the silicon oxide film has a fine uneven structure on a surface thereof, the optical member includes a water-repellent film containing a fluorine compound on the surface of the fine uneven structure, and a surface of the water-repellent film has an adhesion energy of 0.2 mN/m to 6 mN/m.

It is preferable that the fluorine compound contains a —(OCF₂CF₂)ₙ— group in which n represents an integer of 1 or greater and contains no —(OCF₂)ₘ— group in which m represents an integer of 1 or greater.

A sliding angle of a 5 μL water droplet on the surface of the water-repellent film is preferably 10° or less.

In the silicon oxide film, a content of aluminum is preferably 0.25 wt % or less, a content of calcium is preferably 2.0 wt % or less, a content of boron is preferably 2.0 wt % or less, and a content of carbon is preferably 6.0 wt % or less.

It is preferable that the silicon oxide film is a sputtered film or a vapor-deposited film.

In a case where a composition of a silicon oxide contained in the silicon oxide film is represented by SiOx, it is preferable that 1.90≤x≤2.00 is satisfied.

It is preferable that the fine uneven structure has an average height from a bottom of a recess portion of the fine uneven structure to an apex of a protrusion portion of 150 nm to 600 nm and an average period of 150 nm to 450 nm.

In the optical member according to the aspect of the present disclosure, it is preferable that a contact angle of water on the surface of the water-repellent film is 140° or greater.

In the optical member according to the aspect of the present disclosure, it is preferable that a haze is 2.5% or less.

In the optical member according to the aspect of the present disclosure, it is preferable that an average reflectivity in a case where light having a wavelength of 400 nm to 700 nm is perpendicularly incident on the surface is 1% or less.

In the optical member according to the aspect of the present disclosure, it is preferable that a transmission wavefront aberration with respect to light having a wavelength of A nm is 25 or less.

It is preferable that the optical member according to the aspect of the present disclosure comprises an interlayer having a refractive index different from a refractive index of the silicon oxide film for reducing a reflectivity with respect to incident light, between the optical substrate and the silicon oxide film.

According to an aspect of the present disclosure, there is provided a method of producing an optical member comprising: a film forming step of forming a silicon oxide film on one surface of an optical substrate by a vapor phase film forming method; a mask forming step of forming an etching mask on the silicon oxide film; an etching step of etching the silicon oxide film by a vapor phase etching method through the etching mask to form a fine uneven structure on a surface of the silicon oxide film; and a coating step of forming a water-repellent film containing a fluorine compound on a surface of the fine uneven structure, in which in the etching step, etching is performed until a distance from a surface of the silicon oxide film on an optical substrate side to an apex of a maximum protrusion portion of the fine uneven structure is less than a film thickness of the silicon oxide film immediately after the film formation.

According to the optical member and the method of producing an optical member according to the aspect of the present disclosure, it is possible to obtain an optical member having high water repellency and capable of suppressing adhesion of water droplets.

### BRIEF DESCRIPTION OF THE DRAWINGS

FIG. 1 is a schematic cross-sectional view of an optical member according to one embodiment.

FIG. 2 is a schematic cross-sectional view of an optical member of a modification example.

FIG. 3 is a view showing steps of producing an optical member according to one embodiment.

FIG. 4 is a view showing details of a mask forming step.

FIG. 5 is a view showing details of an etching step.

FIG. 6 is a cross-sectional SEM image showing a change in a surface shape of a silicon oxide film with the lapse of a chemical etching time.

FIG. 7 is a view for describing a method of measuring a sliding angle of water.

FIG. 8 is an image of a water droplet in a case where a stage is inclined by 0° and 3.4°.

FIG. 9 is a graph for describing a method of calculating adhesion energy of a surface of an optical member.

FIG. 10 shows images for describing a method of deriving an average height of unevenness of a fine uneven structure (part 1).

FIG. 11 is a graph for describing a method of deriving an average height of unevenness of a fine uneven structure (part 2).

FIG. 12A is an example of an SEM image of the fine uneven structure used in a case of deriving an average period of the unevenness of the fine uneven structure, and FIG. 12B is a spatial frequency spectrum derived from FIG. 12A.

FIGS. 13A and 13B are views for describing a method of evaluating sliding properties.

FIG. 14 is a graph showing a relationship between an etching time and an adhesion energy.

FIG. 15 is a graph showing a contact angle of water at each position on an X-axis.

FIG. 16A is a schematic view for describing an area ratio at which a SiO₂ target and an optical glass piece are disposed, and FIG. 16B is a schematic view showing a state in which the optical glass piece is placed on the SiO₂ target.

FIG. 17A is a captured image of a sample 6-1 during measurement of a transmission wavefront aberration, FIG. 17B is a captured image of a sample 6-2 during measurement of a transmission wavefront aberration, FIG. 17C is a captured image of a sample 6-3 during measurement of a transmission wavefront aberration, and FIG. 17D is a captured image of a sample 6-4 during measurement of a transmission wavefront aberration.

FIG. 18 is a graph showing a relationship between a physical etching time and a transmission wavefront aberration.

FIG. 19 is a graph showing wavelength dependence of the reflectivities of samples 8-1A and 8-1B.

FIG. 20 is a graph showing wavelength dependence of the reflectivities of samples 8-2A and 8-2B.

FIG. 21 is a graph showing wavelength dependence of the reflectivities of samples 8-3A and 8-3B.

### DESCRIPTION OF EMBODIMENTS

Hereinafter, an embodiment of the present disclosure will be explained with reference to the drawings. For easy visual recognition, a film thickness and a ratio of each layer are appropriately changed and drawn, and do not necessarily reflect the actual film thickness and ratio. In the present specification, the numerical ranges shown using “to” indicate ranges including the numerical values described before and after “to” as the lower limits and the upper limits.

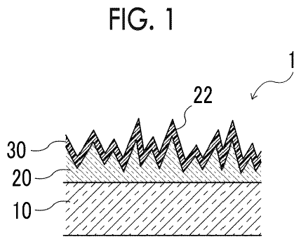

FIG. 1 is a cross-sectional view of an optical member according to one embodiment. An optical member 1 comprises an optical substrate 10 having a smooth surface, a silicon oxide film 20 provided on the optical substrate 10, and a water-repellent film 30 provided on a surface of the silicon oxide film 20. In the optical member 1, the adhesion energy of the surface of the water-repellent film 30 is 0.2 mN/m to 6 mN/m. The adhesion energy is preferably 5.62 mN/m or less, more preferably 2.85 mN/m or less, and still more preferably 0.29 mN/m to 1.29 mN/m.

The shape of the optical substrate 10 is not particularly limited, and the optical substrate 10 is a transparent substrate mainly used in an optical device, such as a flat plate, a concave lens, or a convex lens, and may be a substrate composed of a combination of a curved surface having a positive or negative curvature and a plane.

The silicon oxide film 20 has a fine uneven structure 22 on the surface. In the silicon oxide layer 20, the content of aluminum is 0.25 wt % or less, the content of calcium is 2.0 wt % or less, the content of boron is 2.0 wt % or less, and the content of carbon is 6.0 wt % or less. The content of aluminum is preferably 0.1 wt % or less, the content of calcium is preferably 1.0 wt % or less, the content of boron is preferably 1.0 wt % or less, and the content of carbon is preferably 4.0 wt % or less. Further, the content of a component contained in the silicon oxide layer 20 can be measured by X-ray photoelectron spectroscopy (XPS).

The silicon oxide film 20 is preferably a film prepared by a vapor phase film forming method. Specifically, the silicon oxide film 20 is preferably a sputtered film formed by a sputtering method, a vapor-deposited film formed by a vapor deposition method, or the like.

In a case where the composition of the silicon oxide contained in the silicon oxide layer 20 is represented by SiOx, 1.90≤x≤2.00 is preferable, and 1.95≤x≤2.00 is more preferable.

In the fine uneven structure 22 formed on the surface of the silicon oxide film 20, the average height from the bottom of the recess portion to the apex of the protrusion portion is preferably 150 nm to 600 nm, and the average period of the unevenness is preferably 150 nm to 450 nm. The average height is more preferably 150 nm to 450 nm and still more preferably 200 nm to 350 nm. The average period is more preferably 150 nm to 400 nm and still more preferably 150 nm to 350 nm.

A method of measuring the average height and the average period of the unevenness will be described in examples described below.

The water-repellent film 30 is provided on the surface of the fine uneven structure 22 of the silicon oxide film 20. The water-repellent film 30 constitutes the outermost surface of the optical member 1. The water-repellent film 30 contains a fluorine compound. Examples of the fluorinated compound include SURFCLEAR (manufactured by Canon Optron, Inc.), OPTOOL (HD-1100TH: manufactured by Daikin Industries, Ltd.), FLUOROSURF (NL-1: manufactured by Fluoro Technology Corporation), KY1091 (manufactured by Shin-Etsu Chemical Co., Ltd.), and NB05 (manufactured by KATURAYAMA TECHNOLOGY Inc.). As the fluorine compound constituting the water-repellent film 30, a compound containing a —(OCF₂CF₂)ₙ-group (here, n represents an integer of 1 or greater) and not containing a —(OCF₂)ₘ— group (here, m represents an integer of 1 or greater) is more preferable. As shown in examples described below, a fluorine compound consisting of a functional group of only —(OCF₂CF₂)ₙ-without an —(OCF₂)ₘ— group can have durability higher than that of a fluorine compound containing a functional group of —(OCF₂)ₘ(OCF₂CF₂)ₙ-in the structure thereof (see Table 11 below). In the optical member 1, it is preferable that a sliding angle of a 5 μL water droplet on the surface of the water-repellent film 30 is 10° or less.

The sliding angle is a value measured by the following method. The optical member 1 is placed on a stage having a plane, and a water droplet having a volume of 5 μL is added dropwise onto the surface of the water-repellent film 30. In this state, the stage is gradually inclined at 0.2°/sec. An angle at which the end part of the water droplet begins to move is defined as a sliding angle.

In the optical member 1, the contact angle of water on the surface of the water-repellent film 30 is preferably 140° or greater. The contact angle of water can be measured by a commercially available contact angle meter. In the present specification, the contact angle of water is a static contact angle measured with a water droplet amount of 2 μL.

In the optical member 1, the haze is preferably 2.5% or less. The smaller the haze, the more preferable. In the optical member 1, the scattering in the optical member decreases and the quality increases as the haze decreases. Therefore, it is preferable that the haze decreases as much as possible. The haze can be measured by a commercially available haze meter.

In the optical member 1, an average reflectivity in a case where light having a wavelength of 400 nm to 700 nm is perpendicularly incident on a substrate surface is preferably 1% or less. The average reflectivity means an average of reflectivities at respective wavelengths within a wavelength of 400 nm to 700 nm. The average reflectivity is preferably 1% or less at all wavelengths in a wavelength range of 400 nm to 700 nm. The antireflection performance increases as the reflectivity decreases.

Light is allowed to be incident on the optical member 1 at an incidence angle of 0° to measure the reflectivity for each wavelength. The wavelength dependence of the reflectivity can be measured by a commercially available spectrometer.

In the optical member 1, the transmission wavefront aberration with respect to light having a wavelength of/nm is preferably λ/5 or less. The transmission wavefront aberration can be measured with a commercially available laser interferometer.

As described above, the optical member 1 according to the present embodiment comprises the optical substrate 10 having a smooth surface and the silicon oxide film 20 provided on the optical substrate 10, in which the silicon oxide film 20 has the fine uneven structure 22 on the surface thereof, and the water-repellent film 30 containing a fluorine compound is provided on the surface of the fine uneven structure 22. By providing the water-repellent film 30 on the surface of the fine uneven structure 22 formed on the silicon oxide film 20, extremely high water repellency is obtained as compared with a case where the water-repellent film 30 is provided on a flat surface. By providing the water-repellent film 30 on the surface of the fine uneven structure, the surface area of the water-repellent film can be increased. As a result, a difference between the surface free energy of water and the surface free energy of the optical member increases. As the difference between the surface free energy of water and the surface free energy of the optical member increases, the water repellency increases. In a case where a water-repellent film consisting of a typical fluorine compound is formed by being applied to a flat plate substrate, the contact angle of water on the surface of the water-repellent film is approximately 110°. In the present optical member 1, for example, a contact angle of greater than 120° and a contact angle of 140° or greater can be obtained.

In addition, since the adhesion energy of the surface of the water-repellent film 30 is 0.2 mN/m to 6 mN/m, water droplets that are water-repellent are unlikely to remain on the surface of the optical member 1, and the lotus effect with high water sliding properties is obtained. The sliding properties of water are satisfactory, and the adhesion of water droplets to the surface can be suppressed. Therefore, the optical member 1 is suitable as a lens filter provided on a surface exposed to the outside, such as a camera.

According to the above-described configuration, an optical member in which the sliding angle of a 5 μL water droplet on the surface of the water-repellent film 30 is 10° or less can be realized. In a case where the sliding angle of the water droplet is 10° or less, it can be said that the sliding properties of the water droplet are extremely satisfactory, and the adhesion of the water droplet to the surface can be further suppressed.

In the optical member 1 according to the present embodiment, in the silicon oxide layer 20, the content of aluminum is 0.25 wt % or less, the content of calcium is 2.0 wt % or less, the content of boron is 2.0 wt % or less, and the content of carbon is 6.0 wt % or less. With such a configuration, in a case of preparing the optical member 1, the generation of a compound that reacts with an etching gas and inhibits etching in a case of vapor phase etching of the silicon oxide film 20 can be suppressed (see Test 2 described below). Therefore, the fine uneven structure 22 is likely to be formed.

Further, in a case where the silicon oxide film 20 is a film prepared by a vapor phase film forming method, such as a sputtered film or a vapor-deposited film prepared by a sputtering method or a vapor deposition method, a film in which the impurity concentration is sufficiently reduced can be obtained.

In a case where the composition (SiOx) of the silicon oxide contained in the silicon oxide film 20 satisfies 1.90≤x≤2.00, a difference between the maximum value and the minimum value in the in-plane distribution of the contact angle of water on the surface of the optical member 1, that is, the surface of the water-repellent film 30 can be suppressed to about 10% of the maximum value (see Test 3 described below).

In a case where the average height from the bottom of the recess portion of the fine uneven structure formed on the surface of the silicon oxide film 20 of the optical member 1 to the apex of the protrusion portion is 150 nm to 600 nm and the average period is 150 nm to 450 nm, the water repellency is higher and the adhesion of water droplets can be further suppressed.

In a case where the contact angle of water on the surface of the optical member 1, which is provided with the water-repellent film 30, is 140° or greater, extremely high water repellency is obtained.

### Modification Example

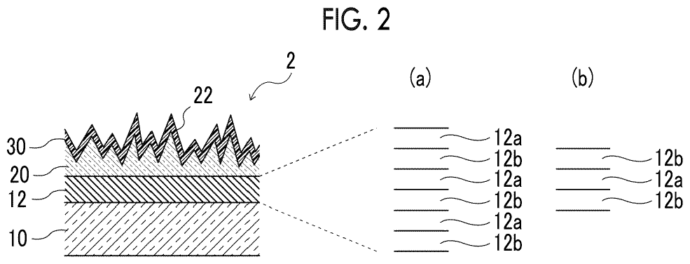

FIG. 2 is a cross-sectional view of an optical member 2 of a modification example. In FIG. 2, the same constituent elements as in FIG. 1 are denoted by the same reference numerals. The optical member 2 comprises an interlayer 12 having a refractive index different from the refractive index of the silicon oxide film 20 for reducing the reflectivity with respect to incident light, between the optical substrate 10 and the silicon oxide film 20. In the present specification, the term “interlayer” denotes a layer provided between the optical substrate 10 and the silicon oxide film 20.

The interlayer 12 may be a single layer or a multilayer film. In a case where the interlayer 12 is a single layer, the optical member 1 having a reflectivity of 1% or less with respect to light having a wavelength of 400 nm to 700 nm can be realized by forming a single-layer dielectric film having a refractive index between the refractive index of the optical substrate 10 and the refractive index of the silicon oxide film 20. In a case where the interlayer 12 is a multilayer film, as shown in (a) of FIG. 2, it is preferable that a layer 12a of a high refractive index with a relatively high refractive index and a layer 12b of a low refractive index with a relatively low refractive index are alternately laminated. In (a) of FIG. 2, the layer 12b of a low refractive index and the layer 12a of a high refractive index are alternately laminated in this order in six layers from the optical substrate 10 side, but the lamination order of the layer 12a of a high refractive index and the layer 12b of a low refractive index may be reversed. The number of layers of the multilayer film is not particularly limited, and as shown in (b) of FIG. 2, the interlayer 12 may have a three-layer configuration.

The layer 12a of a high refractive index may have a refractive index higher than that of the layer 12b of a low refractive index, and the layer 12b of a low refractive index may have a refractive index lower than that of the layer 12a of a high refractive index. However, it is more preferable that the layer 12a of a high refractive index has a refractive index higher than that of the optical substrate 10, and the layer 12b of a low refractive index has a refractive index lower than that of the optical substrate 10.

The layers 12a of a high refractive index or the layers 12b of a low refractive index do not necessarily have the same refractive index. However, it is preferable that the layers are formed of the same material and have the same refractive index from the viewpoint of suppressing the material costs, the film forming costs, and the like.

Examples of the material constituting the layer 12a of a high refractive index include niobium pentoxide (Nb₂O₅), titanium oxide (TiO₂), zirconium oxide (ZrO₂), tantalum pentoxide (Ta₂O₅), silicon oxynitride (SiON), silicon nitride (Si₃N₄), and silicon niobium oxide (SiNbO).

Examples of the material constituting the layer 12b of a low refractive index include silicon oxide (SiO₂), silicon oxynitride (SiON), gallium oxide (Ga₂O₃), aluminum oxide (Al₂O₃), lanthanum oxide (La₂O₃), lanthanum fluoride (LaF₃), magnesium fluoride (MgF₂), and sodium aluminum fluoride (Na₃AlF₆).

The refractive index can be changed to some extent by forming a film by controlling any of these compounds to have a constitutional element ratio shifted from the compositional ratio of the stoichiometric ratio or by controlling the film forming density.

### Production Method

A method of producing the optical member 1 according to the embodiment will be described.

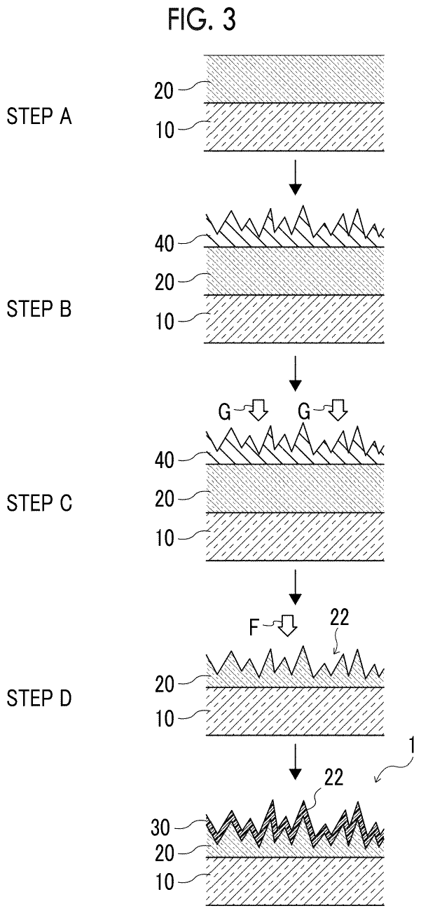

As shown in FIG. 3, the method of producing the optical member 1 includes steps A to D. The step A is a film forming step of forming a silicon oxide film 20 on the optical substrate 10. The step B is a mask forming step of forming a mask 40 on the silicon oxide film 20. The step C is an etching step of performing vapor phase etching on the silicon oxide film 20 with an etching gas G by using the mask 40. The step D is a coating step of forming the water-repellent film 30 on the surface of the etched silicon oxide film 20. An arrow F schematically shows a coating treatment.

In the film forming step (step A), the silicon oxide film 20 is formed on one surface of the optical substrate 10 by a vapor phase film forming method. Examples of the vapor phase film forming method include a sputtering method, a vacuum deposition method, and a chemical vapor deposition method. Among these, a sputtering method is particularly suitable. By using the vapor phase film forming method, it is possible to suppress impurities from being mixed into the silicon oxide film 20. That is, a sputtered film formed by a sputtering method, a vapor-deposited film formed by a vacuum deposition method, or the like can be said to be a film in which mixing of elements (that is, impurities) other than the target is sufficiently suppressed.

In a case where the silicon oxide film 20 is formed by a sputtering method, a SiO₂ target is used, oxygen is introduced into a film forming chamber, and a flow rate of the oxygen is adjusted. Thus, x in the silicon oxide (SiOx) can be optionally adjusted.

The film thickness of the silicon oxide film 20 is, for example, 500 nm to 1,500 nm.

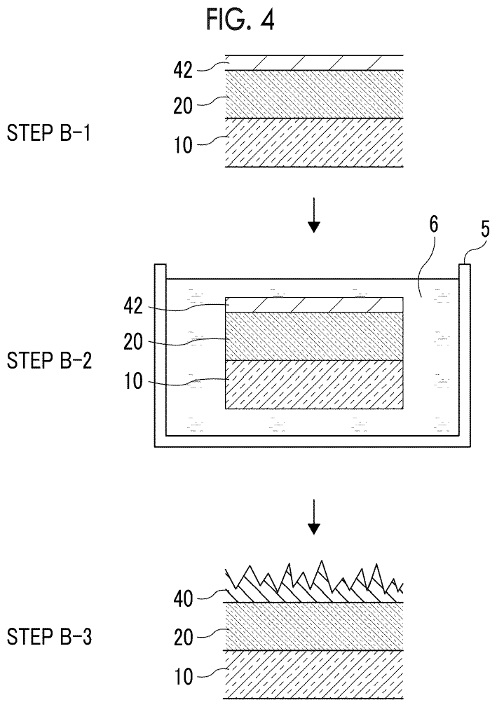

The details of the mask forming step (step B) are shown in FIG. 4. The mask forming step includes, for example, a step B-1 which is an Al-containing thin film forming step of forming a thin film 42 (hereinafter, referred to as an Al-containing thin film 42) containing aluminum on the silicon oxide film 20, and a step B-2 which is a hot water treatment step of performing a hot water treatment on the Al-containing thin film 42, as shown in FIG. 4.

In the Al-containing thin film forming step (Step B-1), the Al-containing thin film 42 is formed by a vapor phase film deposition method. Examples of the vapor phase film forming method include a sputtering method, a vacuum deposition method, and a chemical vapor deposition method. Among these, a sputtering method is particularly suitable. In a case where the silicon oxide film 20 is formed by a sputtering method, the Al-containing thin film 42 is preferably continuously formed in the same chamber.

Examples of the Al-containing thin film 42 include an aluminum film, an aluminum oxide film, and an aluminum nitride film. The film thickness of the Al-containing thin film 42 is preferably 0.5 to 60 nm, more preferably 2 to 40 nm, and still more preferably 5 to 20 nm.

The hot water treatment in the hot water treatment step (step B-2) denotes a treatment of exposing the film to hot water at 60° C. or higher for 1 minute or longer. Examples of the hot water treatment include a method in which a laminate in which the Al-containing thin film 42 is formed is immersed in water (particularly preferably pure water) at room temperature, and the water is boiled, a method in which the laminate is immersed in hot water maintained at a high temperature, and a method in which the Al-containing thin film 42 is exposed to a stem at a high temperature. In the present embodiment, pure water 6 accommodated in a water tank 5 is heated, and the entire laminate consisting of the optical substrate 10, the silicon oxide film 20, and the Al-containing thin film 42 is immersed in the heated pure water 6 to perform a warm water treatment. The boiling or immersing time is particularly preferably 3 minutes or longer and 15 minutes or shorter. The temperature of the hot water is particularly desirably higher than 90° C. The treatment time tends to decrease as the temperature increases.

Due to the hot water treatment, the Al-containing thin film 42 is changed to an uneven structure layer containing an alumina hydrate as a main component, as shown in the step B-3. The uneven structure layer corresponds to the mask 40. The uneven structure layer 40 described below has the same definition as that for the mask 40. The alumina hydrate constituting the uneven structure layer 40 is bochmite (expressed as Al₂O₃·H₂O or AlOOH), which is alumina monohydrate, bayerite (expressed as Al₂O₃·3H₂O or Al(OH)₃), which is alumina trihydrate (aluminum hydroxide), or the like.

In the uneven structure layer 40, the uneven structure has a random shape, and the size (size of an apex angle) and the orientation of the protrusion portion vary, but the uneven structure layer 40 usually has a serrated cross section.

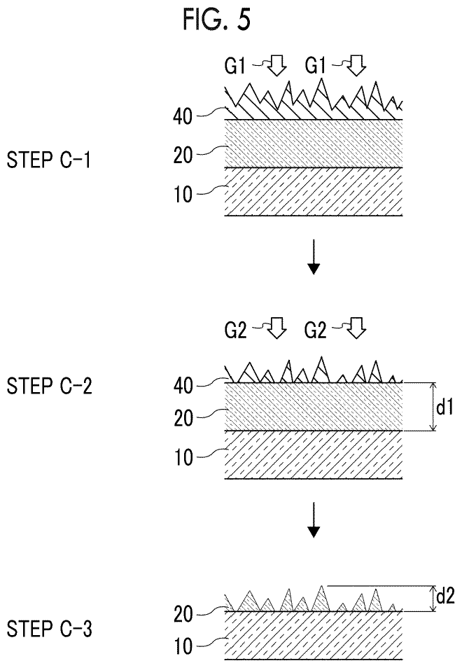

The details of the etching step (step C) are shown in FIG. 5. The etching step includes, for example, a step C-1 which is a physical etching step of physically etching the uneven structure layer 40 according to the shape of the uneven structure layer 40, and a step C-2 to be performed after the step C-1, which is a reactive etching (chemical etching) step of selectively etching the silicon oxide film 20 exposed to the recess portion of the uneven structure layer 40, as shown in FIG. 5.

In the physical etching step (step C-1), the uneven structure layer 40 consisting of an alumina hydrate is etched to expose the silicon oxide film 20 to the recess portion of the uneven structure layer 40. Here, for example, a mixed gas of argon (Ar) and CHF₃ (trifluoromethane) is used as the etching gas G1. A ratio (physical etching time t1/subsequent chemical etching time t2)×100 is preferably 0.56 to 2.22. Specifically, t1 is preferably about 15 seconds to 60 seconds and more preferably 30 seconds to 45 seconds (see Test 6 described below).

In the chemical etching step (step C-2), the silicon oxide film 20 exposed to the recess portions is etched. For example, a mixed gas of SF₆ (sulfur hexafluoride) and CHF₃ is used as an etching gas G2. In this case, SF₆ that is a reactive gas is allowed to act on SiO₂ to generate SiF₄, and SiF₄ is vaporized to chemically etch SiO₂. In the chemical etching step, etching is performed until a distance d2 from the surface of the silicon oxide film 20 on the optical substrate 10 side to the apex of the maximum protrusion portion of the fine uneven structure is less than the film thickness d1 of the silicon oxide film 20 immediately after the film formation. As the chemical etching time t2, the etching time is preferably 600 seconds to 3600 seconds (10 minutes to 60 minutes), more preferably 900 seconds to 3000 seconds (15 minutes to 50 minutes), and particularly preferably 1800 seconds to 2700 seconds (30 minutes to 45 minutes) (see Test 1 described below).

Further, after the chemical etching step, a cleaning treatment step (step C-3) is performed to remove the uneven structure layer 40 remaining on the surface of the silicon oxide film 20.

In the cleaning treatment step (step C-3), the uneven structure layer 40 is removed with SH303 (a mixed solution of sulfuric acid and hydrogen peroxide), the film is dried, and the film is irradiated with ultraviolet rays (UV).

In the coating step (step D), the water-repellent film 30 containing a fluorine compound is formed on the surface of the etched silicon oxide film 20. A coating method may be dry coating or wet coating. Examples of the fluorine compound for dry coating include SURF CLEAR (manufactured by Canon Optron, Inc.), and examples of the fluorine compound for wet coating include OPTOOL (HD-1100TH: manufactured by Daikin Industries, Ltd.), FLUOROSURF (NL-1: manufactured by Fluoro Technology Corporation), KY1091 (manufactured by Shin-Etsu Chemical Co., Ltd.), and NB05 (manufactured by KATURAYAMA TECHNOLOGY Inc.).

Through the above steps, the optical member 1 can be produced.

Further, in a case of preparing the optical member 2 comprising the interlayer 12, the interlayer 12 is formed before the silicon oxide film 20 is formed on the optical substrate 10. It is preferable that the vapor phase film forming method is also used for forming the film of the interlayer 12. According to the vapor phase film formation, a laminated structure having various refractive indices and layer thicknesses can be easily formed.

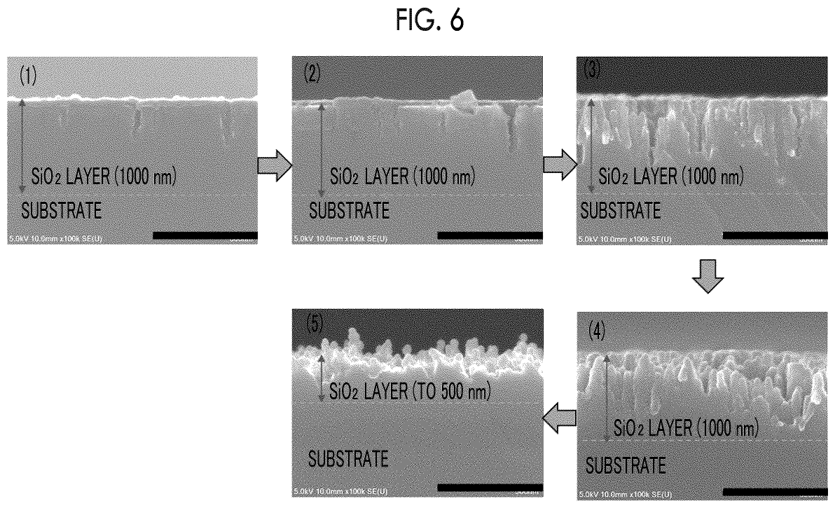

FIG. 6 is a cross-sectional SEM image showing a change in the surface shape of the silicon oxide film with the lapse of the chemical etching time. (1) to (5) show cross sections of samples having different chemical etching times after a silicon oxide film (SiO₂ layer in FIG. 6) having a film thickness of 1000 nm is formed on a substrate and the physical etching step is carried out for 45 seconds by the above-described production step. (1) to (5) are arranged in order of the etching time, (1) is a sample having the shortest etching time, and (5) is a sample having the longest etching time. In a stage where the etching time is relatively short as in (1) and (2), the film is in a state where a recess is formed in a part of the surface, and it cannot be said that the entire surface has unevenness. In a case where the etching time is increased, the number of recess portions is gradually increased, and the silicon oxide film is in a state where the unevenness is formed on substantially the entire surface in (3). After the unevenness is formed on the entire surface thereof, etching proceeds such that the entire surface is scraped off while the uneven shape is maintained. In (4), a flat portion is hardly observed on the surface of the silicon oxide film. Further, in (5) where the etching time is the longest, the etching further proceeds until the distance from the surface of the silicon oxide film 20 on the optical substrate 10 side to the apex of the maximum protrusion portion of the fine uneven structure is less than the film thickness of the silicon oxide film 20 immediately after the film formation. In (5), the distance from the surface of the silicon oxide film on the optical substrate 10 side to the apex of the maximum protrusion portion of the fine uneven structure is approximately 500 nm, which is approximately half of the original film thickness of 1000 nm.

According to the examination conducted by the present inventors, in a case of the samples shown in (3), (4), and (5), an antireflection effect can be sufficiently obtained, and extremely high is exhibited due to the formation of a water-repellent film on the surface. However, a surface having high sliding properties without water droplets adhering to the surface is obtained due to the lotus effect in (5), whereas it was found that water droplets adhere to the surface due to the petal effect, and thus the surface has low sliding properties. This denotes that the adhesion energy of the surface is not in a range of 0.2 mN/m to 6 mN/m in the uneven structure of (3) and (4).

By carrying out the etching until the distance from the surface of the silicon oxide film 20 on the optical substrate 10 side to the apex of the maximum protrusion portion of the fine uneven structure is less than the film thickness of the silicon oxide film 20 immediately after the film formation, a fine uneven structure having a cross-sectional structure as shown in (5) can be obtained. That is, an optical member in which the adhesion energy of the surface is in a range of 0.2 mN/m to 6 mN/m can be realized.

Further, in the above-described chemical etching, in a case where the silicon oxide film 20 contains an impurity element that generates a compound that is difficult to react with an etching gas and gasify, the reaction between SiO₂ and the reactive gas can be inhibited. In a case where the reaction between SiO₂ and the reactive gas is inhibited, a problem in that the etching rate slows down or is unstable, or the etching does not proceed occurs. Examples of the impurity element that generates a fluorine compound that is difficult to react with SF₆ and gasify include aluminum, calcium, boron, and carbon. As described above, in a case where the silicon oxide film 20 is formed by a vapor phase film forming method such as film formation by sputtering using a SiO₂ target, the mixing of these impurity elements can be sufficiently suppressed as compared with the film formation by a liquid phase film forming method such as sol-gel, and a problem of etching inhibition does not occur in the chemical etching step.

In addition, optical substrates used in cover glass, lenses, and the like may contain a metal (for example, AI or Ca) other than Si to lower a softening point or adjust a refractive index. Therefore, in a case where an uneven structure is directly formed on the surface of the optical member by etching the surface of the optical substrate, the above-described problem may occur in the chemical etching step of the step C-2, and it may take time to form the uneven structure or it may not be possible to form an uneven structure having a sufficient depth. In the present method of producing the optical member 1, the silicon oxide film 20 is formed on the optical substrate 10, and thus even in a case where impurity elements are mixed into the optical substrate 10, the optical substrate 10 can be applied without any problem regardless of the material thereof.

In addition, in the optical member that comprises the silicon oxide film 20 on the optical substrate 10 and the fine uneven structure 22 on the surface of the silicon oxide film 20, and does not comprise the water-repellent film 30, the surface of the fine uneven structure 22 exhibits superhydrophilicity. In a case of an optical member comprising the fine uneven structure 22 having superhydrophilicity, water spreads on the surface, and thus the adhesion of water on the surface can be suppressed, and as a result, an effect of preventing the adhesion of raindrops and the like can be obtained. However, in a camera comprising such an optical member comprising a film having superhydrophilicity as a lens filter, in a case where water that has spread on the lens filter during imaging is dried, the water may not be uniformly dried, and wet and dry areas may be formed, which may deteriorate the visible image. Since the optical member 1 comprises the water-repellent film 30, an effect of repelling raindrops and the like is obtained, and an effect of preventing stains is also obtained as compared with a case where water spreads. Therefore, even in a case where the optical member is used as the lens filter of a camera, the image deterioration as described above does not occur, and thus the optical member is extremely preferable in practical use.

### EXAMPLES

Samples of examples and comparative examples of the optical member were prepared, various tests were performed, and the results of the verification of the optical member according to the present disclosure will be described.

In the preparation of samples used in tests, an RF magnetron sputtering device BMS-800II (SHINCRON CO., LTD.) was used as a film forming device. Film forming conditions for each film will be described below.

Characteristics of each sample were measured by the following measuring methods.

### (Reflectivity)

A microspectrophotometer (USPM-PU: Olympus Corporation) was used to measure the reflectivity. The reflectivity for each wavelength in a case where the light was incident on the optical member at an incidence angle of 0° (vertical incidence) was measured.

### (Contact Angle of Water)

A contact angle meter (DM300: Kyowa Interface Science Co., Ltd.) was used to measure the contact angle of water. Here, the static contact angle was measured with a water droplet amount of 2 μL.

### (Sliding Angle of Water)

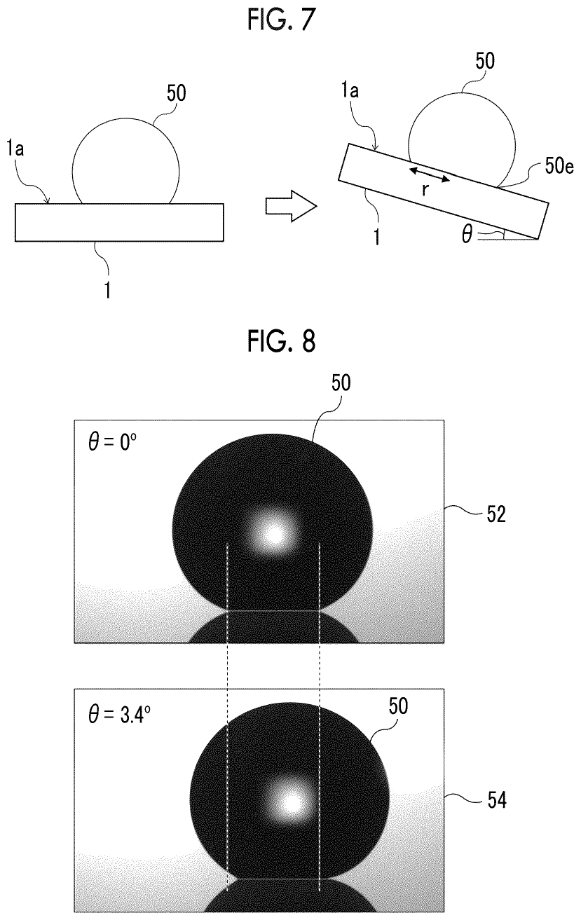

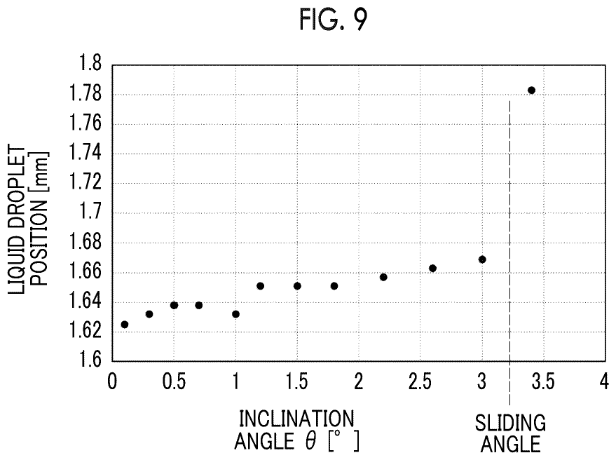

A method of measuring the sliding angle of water will be described with reference to FIG. 7. The optical member 1 was placed on a stage (not shown) having a plane, and a water droplet 50 having a volume of 5 μL was added dropwise onto a surface (surface of the water-repellent film) la of the optical member 1. In this state, the stage was gradually inclined at 0.2°/sec to gradually lift one end side (a left side in the drawing) of the optical member 1 to incline the optical member 1. In FIG. 7, the inclination angle is represented by θ. The inclination angle θ was gradually increased, and an angle at which the end part 50e of the water droplet 50 started to move is defined as the sliding angle. An image 52 of FIG. 8 is an image obtained by imaging the water droplet 50 on the optical member 1 in a state where the plane of the stage was horizontally positioned, that is, in a case where the inclination angle θ was 0°, and an image 54 of FIG. 8 is an image obtained by imaging the water droplet 50 on the optical member 1 in a state where the plane of the stage was inclined at an inclination angle θ of 3.4°. Here, the optical member 1 was inclined in a direction in which the right side of the paper surface in FIG. 8 was down and the left side thereof was up. As indicated by the broken line, deviation occurs at the position of the water droplet 50 at an inclination angle θ of 0° and at the position of the water droplet 50 at an inclination angle θ of 3.4°. A change in position of an end part on the right side of the water droplet 50, that is, the side inclined downward was measured. FIG. 9 shows an example in which a relationship between the inclination angle [°] of the stage and the position (liquid droplet position) of the end part 50e of the water droplet 50 was measured. As shown in FIG. 9, the angle at which the liquid droplet position was greatly changed was defined as the sliding angle. In the example shown in FIG. 9, since the sliding angle was greatly changed between the inclination angle of 3.4° that had been greatly changed and the inclination angle of 3.0° immediately before the change, an angle of 3.2° between the measurement points was defined as the sliding angle. Further, the sliding angle was measured 10 times for one optical member, and the average value of the 10 measured values was defined as the sliding angle of the optical member.

### (Adhesion Energy)

The adhesion energy was calculated from the above-described sliding angle of water using the following expression (1).

As shown in FIG. 7, it is assumed that a surface 1a of the optical member 1 is a flat surface and a contact surface of the water droplet 50 that is in contact with the surface 1a of the optical member is circular, and a radius of the contact surface is defined as r. The slide angle obtained by the above-described procedure is defined as a. In a case where the weight of the water droplet 50 is defined as m, the volume of the water droplet 50 is defined as V, and the density of the water droplet 50 is defined as p, the component of the gravity acting downward on the inclined surface with respect to the water droplet 50 at the sliding moment is expressed as “mg·sinα=Vρg·sinα”.

In a case where the adhesion energy of the surface 1a of the optical member 1 is defined as E, the force with which the surface 1a of the optical member 1 supports the water droplet 50 is 2πrE.

At the moment when the liquid droplet slides, the component of the gravitatiy and the force supporting the water droplet are balanced. That is, a relationship of “Vρg·sinα=2πrE” is satisfied. Therefore, the adhesion energy E is represented by Equation (1).

$$E = V ρ g \cdot sin α / 2 π r \qquad ( 1 )$$

Further, in the present example, the adhesion energy E was calculated using the sliding angle α measured using a water droplet having a volume V of 5 μL. Here, the sliding angle α is a value that changes depending on the volume V of the water droplet 50, and the adhesion energy E does not depend on the volume V of the water droplet 50.

### (Haze)

A haze meter (NDH5000: NIPPON DENSHOKU INDUSTRIES CO., LTD.) was used to measure the haze.

$$Haze [ \% ] = ( amount of diffused transmitted light / ( amount of vertically transmitted light + amount of diffused transmitted light ) ) \times 100$$

A larger haze means a larger amount of diffuse transmitted light.

### (Average Height of Unevenness)

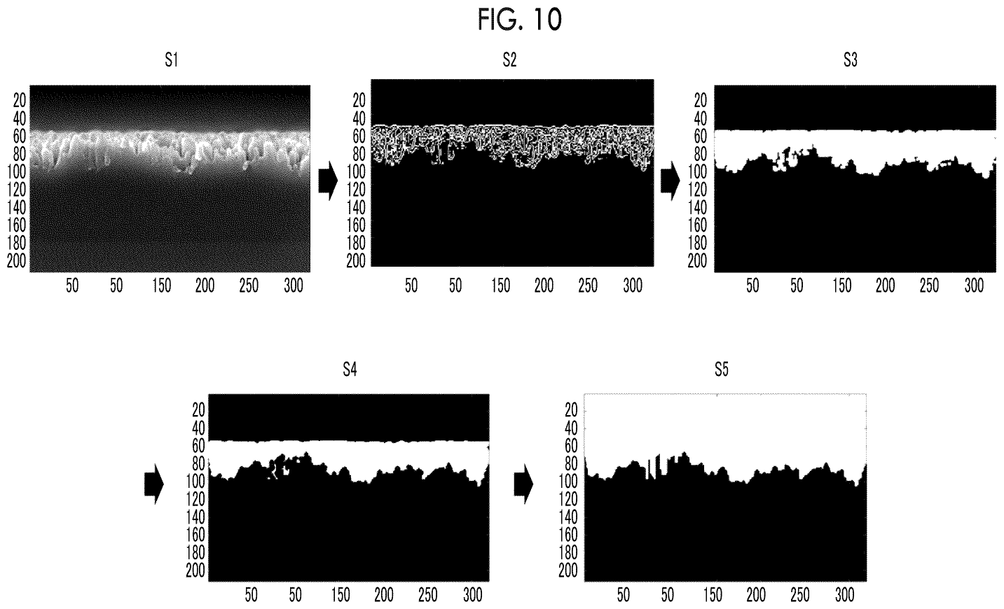

The average height of the unevenness is an average height from the bottom of the recess portion to the apex of the protrusion portion of the fine uneven structure formed on the surface of the silicon oxide film, and is derived as follows. The calculation method will be described with reference to FIG. 10.

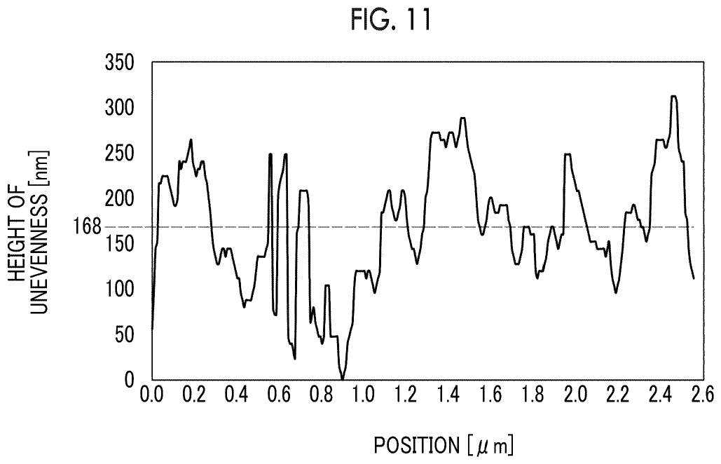

First, a cross section of the optical member was imaged at a magnification of 50,000 times with a scanning electron microscope (SEM) to acquire an SEM image (213× 320 [pix]) (S1). This corresponds to a region of 1.7 μm in length×2.56 μm in width. In FIG. 10, the vertical axis and the horizontal axis in each image indicate the number of pixels. The SEM image was binarized to detect edges of the uneven structure (S2), a filling process of filling the recess portion was performed (S3), noise was removed (S4), and a boundary between the unevenness and air as the surface of the unevenness was determined (S5). By performing the treatments of S1 to S5, for example, a boundary line of the unevenness with the deepest position shown in FIG. 11 being set as a height of 0 is determined. As shown in FIG. 11, the height of the unevenness is random, and the apex of the maximum protrusion portion is about 310 nm. However, in a case where the uneven height is integrated and averaged, the average height of the unevenness in the example shown in FIG. 11 is 168 nm indicated by a broken line. Further, FIG. 11 is data for a sample 1-4 of Test 1 described below.

### (Average Period of Unevenness)

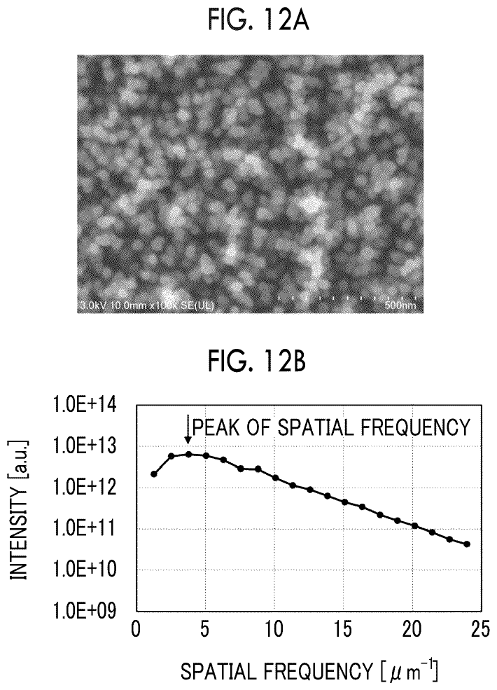

Regarding the average period, each spatial frequency spectrum is determined to determine the spatial frequency value having the maximum intensity, and a period is determined from the spatial frequency value. Specifically, a SEM image (see FIG. 12A) of the fine uneven structure in a plan view was acquired at a magnification of 10,000 times with a scanning electron microscope, a range of 1,000×680 pixels was cut out from the SEM image, and two-dimensional Fourier transform was performed. Further, in the image of FIG. 12A, one pixel corresponds to 10 nm. The square intensity spectrum of the obtained two-dimensional spatial frequency was integrated in an azimuthal angle direction and the intensity of the spectrum corresponding to the magnitude of the spatial frequency was determined to calculate the relationship between the one-dimensional spatial frequency and the spectrum intensity. Further, the spatial frequency value at which the maximum intensity (peak) was obtained by fitting the vicinity of the apex with a Gaussian function was determined (see FIG. 12B). For example, in a case where the spatial frequency value at which the intensity is maximum is 5 μm⁻¹, the period [μm] is ⅕=0.2, and the average period is 200 nm.

### “Test 1”

Samples 1-1 to 1-10 of an optical member comprising a silicon oxide film on an optical substrate, a fine uneven structure on a surface of the silicon oxide film, and a water-repellent film on the fine uneven structure were prepared, and various evaluations were performed.

### (Sample Preparation Method)

A preparation method of the samples 1-1 to 1-10 was as follows.

A white board substrate (B270i: manufactured by SCHOTT AG) having a diameter of 80 mm and a thickness of 2.5 mm was used as an optical substrate. A silicon oxide film with a thickness of 100 nm was formed on the white board substrate by a sputtering method, and an aluminum film with a thickness of 10 nm was further formed thereon by a sputtering method. Next, the white board substrate on which the silicon oxide film and the aluminum film were laminated was subjected to a hot water treatment of immersing the white substrate in hot water at 100° C. for 3 minutes. In this manner, the aluminum film was changed into a fine uneven layer consisting of an alumina hydrate.

A SiO₂ target was used for the formation of the silicon oxide film, and an AI target was used for the formation of the aluminum film. Sputtering conditions were as follows.
Sputtering Conditions for Silicon Oxide Film

Target input power: 500 W

Vacuum degree: 0.2 Pa, Ar/O₂ mixed atmosphere (O₂ flow rate: 200 sccm) No substrate heating

### Sputtering Conditions for Aluminum Film

Target input power: 600 W

Vacuum degree: 0.2 Pa, Ar atmosphere (Ar flow rate: 200 sccm)

No substrate heating

Thereafter, an etching treatment was performed using the fine uneven layer as a mask. First, physical etching was carried out, and subsequently, chemical etching was carried out. The physical etching was performed to penetrate recess portions of the fine uneven layer so that the silicon oxide layer was exposed. Thereafter, the chemical etching was performed to etch the silicon oxide film exposed to the recess portions of the fine uneven layer. The conditions for the physical etching and the chemical etching were as follows.

### Physical Etching Conditions

### Inductively Coupled Plasma (ICP) Output: 300 W, Bias Output: 120 W

Etching Pressure: 3 Pa

Etching Gas: Ar (100 sccm), CHF₃ (10 sccm)

Substrate Temperature: 10° C.

Etching Time: 45 sec.

### Chemical Etching Conditions

ICP output: 500 W, bias output: 15 W

Etching pressure: 0.6 Pa

Etching gas: SF₆ (40 sccm), CHF₃ (40 sccm)

Substrate Temperature: 10° C.

Etching gime: 5 min to 70 min (varies depending on the sample)

The etching time for each of the samples 1-1 to 1-10 is listed in Table 1.

The uneven structure formed on the surface of the silicon oxide film by the etching treatment was dip-coated with a fluorine coat (trade name: FLUOROSURF NL-1, manufactured by Fluoro Technology Corporation), thereby forming a water-repellent film.

The evaluation results of the calculated adhesion energy and the sliding properties of water on the surface of each of the samples 1-1 to 1-10 prepared as described above are listed in Table 1.

### (Evaluation of Sliding Properties of Water)

A method of evaluating the sliding properties of water will be described. First, the number of residual water droplets was measured by the following procedure.

1) Pure water was put into an empty spray container of a commercially available Hydro Ag alcohol spray (manufactured by FUJIFILM Corporation).

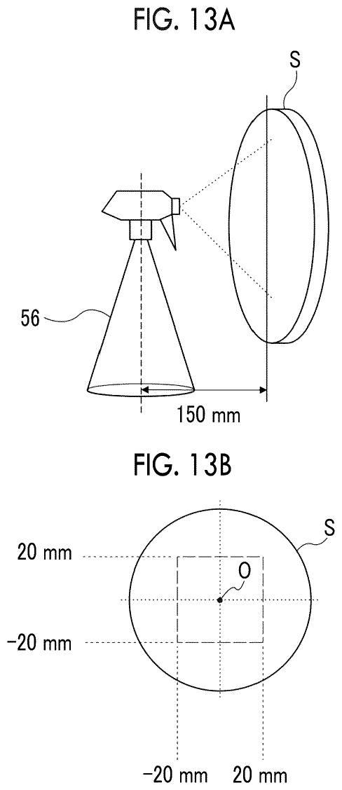

2) As shown in FIG. 13A, a sample S (each of the samples 1-1 to 1-10) was vertically erected using a jig (not shown), and a spray container 56 was installed such that the distance from the surface of the sample S to the center of the bottom surface of the spray container 56 reached 150 mm.

3) In this state, the spray lever was pressed three times, and pure water was sprayed on the surface of the sample S.

4) Thereafter, the sample S was horizontally placed, and the number of water droplets remaining on the surface was counted. The surface of the sample S was observed at a magnification of 5 times using an actual object microscope. As shown in FIG. 13B, a range of 40×40 mm centered on the center O of the sample S was divided into four regions, the number of water droplets in each of a 20×20 mm region of a first quadrant, a 20×20 mm region of a second quadrant, a 20×20 mm region of a third quadrant, and a 20×20 mm region of a fourth quadrant was counted, and the average number of water droplets in the four regions was defined as the number of residual water droplets.

The number of residual water droplets was evaluated for each of the samples 1-1 to 1-10 according to the following standard. The evaluation results of the sliding properties of water are listed in Table 1.

A: The number of residual water droplets was 2 or less.

B: The number of residual water droplets was 3 or more and 5 or less.

C: The number of residual water droplets was 6 or more and 10 or less.

D: The number of residual water droplets was more than 10.

TABLE 1

| Sample | Chemical etching | Adhesion energy | Sliding properties |
|---|---|---|---|
| No. | time (min) | [mN/m] | of water |
| 1-1 | 5 | 16.18 | D |
| 1-2 | 10 | 4.25 | C |
| 1-3 | 15 | 2.29 | B |
| 1-4 | 30 | 0.29 | A |
| 1-5 | 35 | 0.57 | A |
| 1-6 | 40 | 0.86 | A |
| 1-7 | 45 | 1.29 | A |
| 1-8 | 50 | 2.85 | B |
| 1-9 | 60 | 5.62 | C |
| 1-10 | 70 | 15.44 | D |

In the samples 1-2 to 1-9 in which the adhesion energy was in a range of 0.2 mN/m to 6 mN/m, the sliding properties were evaluated as C or higher. On the contrary, in the samples 1-1 and 1-10 in which the adhesion energy was not in a range of 0.2 mN/m to 6 mN/m, the sliding properties were evaluated as D. The samples 1-2 to 1-9 correspond to the examples of the optical member according to the present disclosure, and the samples 1-1 and 1-10 correspond to the comparative examples. Satisfactory sliding properties were obtained in a case where the adhesion energy was 5.62 mN/m or less, more satisfactory sliding properties were obtained in a case where the adhesion energy was 2.85 mN/m or less, and extremely satisfactory sliding properties were obtained in a case where the adhesion energy was 0.29 mN/m to 1.29 mN/m.

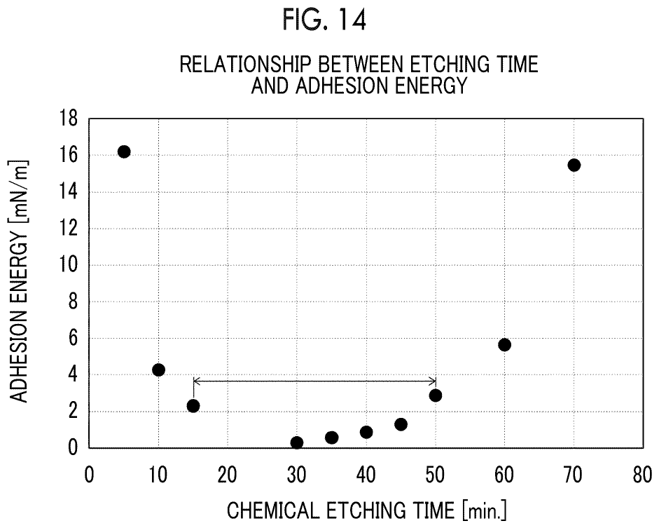

FIG. 14 shows the etching time dependence of the adhesion energy based on Table 1. In Test 1, the chemical etching time for realizing satisfactory sliding properties was 10 minutes to 60 minutes. In addition, more satisfactory sliding properties were obtained in a case where the chemical etching time was set to 15 minutes to 50 minutes, and extremely satisfactory sliding properties were obtained in a case where the chemical etching time was set to 30 minutes to 45 minutes. In FIG. 14, a range indicated by a two direction arrow is a range in which satisfactory sliding properties are obtained. It is considered that the etching is insufficient and the formation of the uneven structure is insufficient in a case where the etching time is shorter than 5 minutes, and the etching extremely proceeds and the uneven structure that has been formed once is destroyed in a case where the etching time is longer than 60 minutes.

Here, the contact angle β of water, the sliding angle α of water, the reflectivity R, and the haze H were evaluated for the samples 1-1 to 1-7. Table 2 lists the evaluation standards, and Table 3 lists the evaluation results. In addition, Table 3 lists the evaluation of the sliding properties and the adhesion energy listed in Table 1 together.

TABLE 2

| | A | B | C | D |
|---|---|---|---|---|
| Contact angle β of water | β > 140° | 140° > β > 130° | 130° > β > 120° | β < 120° |
| (static) | | | | |
| (water with volume of 2 μL) | | | | |
| Sliding angle α of water | α < 5° | 5° < α < 10° | 10° < α < 30° | α > 30° |
| (water with volume of 5 μL) | | | | |
| Reflectivity R | R < 1.0% | 1.0% < R < 1.5% | 1.5% < R < 2.0% | R > 2.0% |
| (average value at wavelength | | | | |
| of 400 to 700 nm) | | | | |
| Haze value H | H < 2.5% | 2.5% < H < 3.0% | 3.0% < H < 4.0% | H > 4.0% |

The evaluation standards listed in Table 2 were the same even in Test 2 and the subsequent tests.

TABLE 3

| | | Evaluation | | | | | |
|---|---|---|---|---|---|---|---|
| | Chemical | | | | | Sliding | |
| | etching time | Contact angle of | Sliding angle of | | | properties of | Adhesion energy |
| Sample No. | (min) | water | water | Reactivity | Haze | water | [mN/m] |
| 1-1 | 5 | D | D | D | B | D | 16.18 |
| 1-2 | 10 | C | C | D | B | C | 4.25 |
| 1-3 | 15 | A | B | A | D | B | 2.29 |
| 1-4 | 30 | A | A | B | B | A | 0.29 |
| 1-5 | 35 | A | A | B | B | A | 0.57 |
| 1-6 | 40 | A | A | B | B | A | 0.86 |
| 1-7 | 45 | A | A | B | B | A | 1.29 |

As listed in Table 3, the evaluation of the sliding properties of water and the evaluation of the sliding angle of water were consistent. In a case where the adhesion energy was in a range of 0.29 mN/m to 1.29 mN/m, all the evaluation results were B or higher.

### Test 2

Samples 2-1 to 2-7 of an optical member having a fine uneven structure on a surface of an optical substrate and a water-repellent film on the fine uneven structure were prepared, and various evaluations were performed. All the samples 2-1 to 2-7 corresponded to the comparative examples of the optical member according to the present disclosure in terms that a silicon oxide film was not provided.

### (Sample Preparation Method)

A preparation method of the samples 2-1 to 2-7 was as follows.

A white board substrate (B270I: manufactured by SCHOTT AG) having a diameter of 80 mm and a thickness of 2.5 mm was used as an optical substrate. An aluminum film with a thickness of 10 nm was formed on the white board substrate by a sputtering method. Next, the white board substrate on which the aluminum film was laminated was subjected to a hot water treatment of immersing the white substrate in hot water at 100° C. for 3 minutes. In this manner, the aluminum film was changed into a fine uneven layer consisting of an alumina hydrate.

An AI target was used for forming an aluminum film, and the sputtering conditions were the same as in Test 1.

Thereafter, an etching treatment was performed using the fine uneven layer as a mask. First, physical etching was carried out, and subsequently, chemical etching was carried out. The physical etching was performed to penetrate recess portions of the fine uneven layer so that the surface of the white board substrate was exposed. Thereafter, the white board substrate exposed to the recess portions of the fine uneven layer was etched by chemical etching. The conditions for the physical etching and the chemical etching were the same as in Test 1. Further, the chemical etching time is in a range of 5 minutes to 45 minutes and varies depending on the sample. The chemical etching time for each sample is listed in Table 4.

The uneven structure formed on the surface of the white board substrate by the etching treatment was dip-coated with a fluorine coat (trade name: FLUOROSURF NL-1, manufactured by Fluoro Technology Corporation), thereby forming a water-repellent film.

The contact angle β of water, the sliding angle α of water, the reflectivity R, and the haze H were evaluated for the samples 2-1 to 2-7 prepared as described above according to the evaluation standards listed in Table 2. The evaluation results are listed in Table 4.

TABLE 4

| | | Evaluation | | | |
|---|---|---|---|---|---|
| Sample | Chemical etching | Contact angle | Sliding angle | Reac- | |
| No. | time (min) | of water | of water | tivity | Haze |
| 2-1 | 5 | D | D | D | B |
| 2-2 | 10 | D | D | D | B |
| 2-3 | 15 | D | D | D | B |
| 2-4 | 30 | D | D | D | B |
| 2-5 | 35 | D | D | D | B |
| 2-6 | 40 | D | D | D | B |
| 2-7 | 45 | D | D | D | B |

All the samples 2-1 to 2-7 had a result of degraded sliding properties. Further, as a result of surface analysis (photoelectron spectroscopy: XPS) of the sample, AI and F were detected on the surface. As shown in the results of the surface analysis, it is presumed that AI in the white board substrate reacted with the etching gas to form AlF₃ having a low vapor pressure, and remained on the surface to inhibit etching.

### “Test 3”

The composition dependence of the SiOx film on the etching distribution was examined.

### (Sample Preparation Method)

A white board substrate (B270i: manufactured by SCHOTT AG) having a diameter of 80 mm and a thickness of 2.5 mm was used as an optical substrate. A silicon oxide film (SiOx film) with a thickness of 1000 nm was formed on the white board substrate by a sputtering method, and an aluminum film with a thickness of 10 nm was further formed on the white board substrate by a sputtering method. The conditions for forming the silicon oxide film will be described below. The conditions for forming the aluminum film were the same as in Test 1. Next, the white board substrate on which the silicon oxide film and the aluminum film were laminated was subjected to a hot water treatment of immersing the white substrate in hot water at 100° C. for 3 minutes. In this manner, the aluminum film was changed into a fine uneven layer consisting of an alumina hydrate.

Thereafter, an etching treatment was performed using the fine uneven layer as a mask. First, physical etching was carried out, and subsequently, chemical etching was carried out. The physical etching was performed to penetrate recess portions of the fine uneven layer so that the silicon oxide layer was exposed. Thereafter, the chemical etching was performed to etch the silicon oxide film exposed to the recess portions of the fine uneven layer. The conditions for the physical etching and the chemical etching were the same as in Test 1 except that the etching time for the chemical etching was set to 30 minutes in all the samples.

The uneven structure formed on the surface of the silicon oxide film by the etching treatment was dip-coated with a fluorine coat (trade name: FLUOROSURF NL-1, manufactured by Fluoro Technology Corporation), thereby forming a water-repellent film.

### Formation of Silicon Oxide Film

In the formation of the silicon oxide film, a SiO₂ target was used, and samples comprising SiOx films with different x values were prepared by changing the target input power and the flow rate of the oxygen gas O₂. Table 5 lists the composition ratio x, the target input power, and the flow rate of the oxygen gas. Other conditions were the same as in Test 1.

TABLE 5

Conditions for film formation

| Compositional | Flow rate of oxygen | Target input power |
|---|---|---|
| ratio x | [sccm] | [W] |
| 2 | 200 | 500 |
| 1.95 | 150 | 450 |
| 1.9 | 150 | 400 |
| 1.8 | 100 | 400 |
| 1.5 | 50 | 350 |

Further, the composition ratio x was measured by a Rutherford backscattering spectroscopy (RBS) device. For the measurement, an RBS device (device main body: 3SDH-R10, accelerator: 3SDHPelletron, manufactured by NEC Corporation) was used, and RBS-400 (manufactured by CE&A Co., Ltd.) was used as data analysis software.

The contact angle distribution in the substrate surface was measured for each sample. The water contact angle was measured at intervals of 5 mm on the X-axis and the Y-axis, which are two axes orthogonal to each other, with the center of the sample having a diameter of 80 mm as the origin. The measurement results are listed in Table 6. (1) shows the contact angle [°] of water at each position X on the X-axis of each sample, and (2) shows the contact angle [°] of water at each position Y on the Y-axis of each sample.

TABLE 6

| | Position X [mm] | | | | | | | | | | | | | | |
|---|---|---|---|---|---|---|---|---|---|---|---|---|---|---|---|
| Compositional ratio x | −35 | −30 | −25 | −20 | −15 | −10 | 5 | 0 | 5 | 10 | 15 | 20 | 25 | 30 | 35 |

(1) Contact angle on X-axis

| | | | | | | | | | | | | | | | |
|---|---|---|---|---|---|---|---|---|---|---|---|---|---|---|---|
| 2 | 140 | 145 | 150 | 150 | 150 | 150 | 150 | 150 | 150 | 150 | 150 | 150 | 150 | 145 | 140 |
| 1.95 | 140 | 140 | 145 | 150 | 150 | 150 | 150 | 150 | 150 | 150 | 150 | 150 | 145 | 140 | 140 |
| 1.9 | 135 | 140 | 145 | 150 | 150 | 150 | 150 | 150 | 150 | 150 | 150 | 150 | 145 | 140 | 135 |
| 1.8 | 100 | 110 | 120 | 135 | 140 | 145 | 150 | 150 | 150 | 145 | 140 | 135 | 120 | 110 | 100 |
| 1.5 | 60 | 70 | 80 | 80 | 90 | 100 | 115 | 120 | 115 | 100 | 90 | 80 | 80 | 70 | 60 |

(2) Contact angle on Y-axis

| | | | | | | | | | | | | | | | |
|---|---|---|---|---|---|---|---|---|---|---|---|---|---|---|---|
| 2 | 140 | 145 | 150 | 150 | 150 | 150 | 150 | 150 | 150 | 150 | 150 | 150 | 150 | 145 | 140 |
| 1.95 | 140 | 140 | 145 | 150 | 150 | 150 | 150 | 150 | 150 | 150 | 150 | 150 | 145 | 140 | 140 |
| 1.9 | 135 | 140 | 145 | 150 | 150 | 150 | 150 | 150 | 150 | 150 | 150 | 150 | 145 | 140 | 135 |
| 1.8 | 100 | 110 | 120 | 135 | 140 | 145 | 150 | 150 | 150 | 145 | 140 | 135 | 120 | 110 | 100 |
| 1.5 | 60 | 70 | 80 | 80 | 90 | 100 | 115 | 120 | 115 | 100 | 90 | 80 | 80 | 70 | 60 |

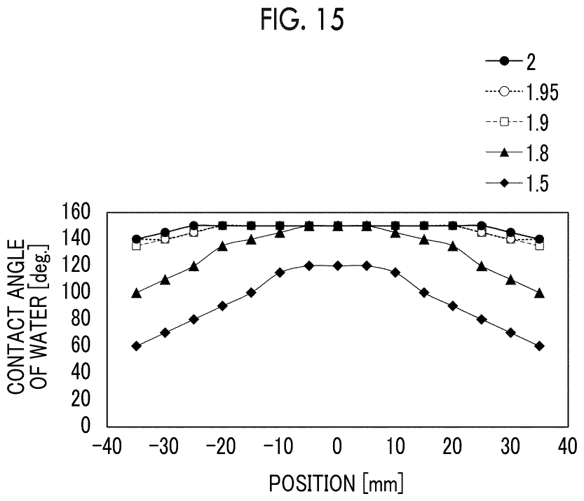

In the present example, the contact angle distribution had substantially the same symmetry in the X-axis direction and the Y-axis direction. FIG. 15 shows the relationship between the position on the X-axis and the contact angle. As shown in FIG. 15, the contact angle decreases from the center (position 0) of the substrate toward the outside. A difference in contact angle between the center position 0 and the position of +35 mm in a range of 1.9≤x≤2.0 can be set to about 10% of the contact angle at the center position of 0 mm. That is, in a case where a range of 1.95≤x≤2.0 is satisfied, the difference in contact angle between the inside and the outside can be further reduced, which is preferable.

As a known phenomenon in the vapor phase etching, the etching amount is different between the center and the end of the substrate. It is considered that this phenomenon is due to the fact that the distribution of plasma in which the etching gas is separated into electrons and ions is not uniform on the substrate and is concentrated on the periphery (edge) of the substrate, and the etching amount is larger on the end part side of the substrate than in the center portion. Further, as shown in the results in Table 6, it was clarified that the difference in the etching amount between the center and the end of the substrate changes depending on the composition ratio x of SiOₓ. In a case where the oxygen composition in the silicon oxide film decreases, the Si concentration relatively increases. The etching rate of the etching gas SF₆+CH₃F used for chemical etching is Si>SiOₓ, and the Si-rich film is likely to be etched. It is considered that the distribution of the etching amount in the substrate surface changes depending on the compositional ratio x of SiOₓ due to a synergistic effect of this tendency and a phenomenon in which plasma is likely to be concentrated around the substrate.

The results of measuring the height of the unevenness at three sites of the center portion of the substrate on the X-axis, the intermediate portion (1/2 portion) between the center and the end part, and the end part of the substrate for each sample are listed in Table 7. In Table 7, the unevenness height is shown as a standardized value in which the highest unevenness height (unevenness height in the center portion of the substrate of the sample having a composition ratio x of 2) is set to 1.

TABLE 7

Measurement position

| Compositional | Center portion | ½ | End part |
|---|---|---|---|
| ratio x | of substrate | portion | of substrate |
| 2 | 1.00 | 0.99 | 0.98 |
| 1.95 | 0.95 | 0.90 | 0.87 |
| 1.9 | 0.95 | 0.85 | 0.82 |
| 1.8 | 0.95 | 0.80 | 0.76 |
| 1.5 | 0.86 | 0.75 | 0.66 |

As listed in Table 7, a difference in unevenness height, that is, a difference in etching amount between the center portion and the end part of the substrate is significant in a case where the compositional ratio x is 1.8 or less. Since there is a correlation between the in-plane distribution of the unevenness height and the in-plane distribution of the contact angle listed in Table 6, it is considered that the in-plane distribution of the unevenness height is a factor of the in-plane distribution of the contact angle.

### “Test 4”

In Test 2, it was shown that in a case where a white board substrate (B270i: manufactured by SCHOTT AG) was used as the optical substrate and the surface thereof was etched to form a fine uneven structure, the uneven structure could not be formed due to the inhibition of the etching. As Test 4, a sample to which impurities were added in a case of forming a silicon oxide film on an optical substrate was prepared, and an experiment was performed to define the concentration of impurities at which the etching was not inhibited.

The elements that can react with SF₆, which is an etching gas, to form a compound are boron (B), calcium (Ca), aluminum (Al), and carbon (C). Therefore, these elements (hereinafter, collectively referred to as impurity elements) were examined. During the formation of the silicon oxide film, an optical glass piece containing any of Al, Ca, or B or a carbon piece as a custom-made product was placed on a SiO₂ target for film formation, thereby preparing a silicon oxide film containing impurity elements.

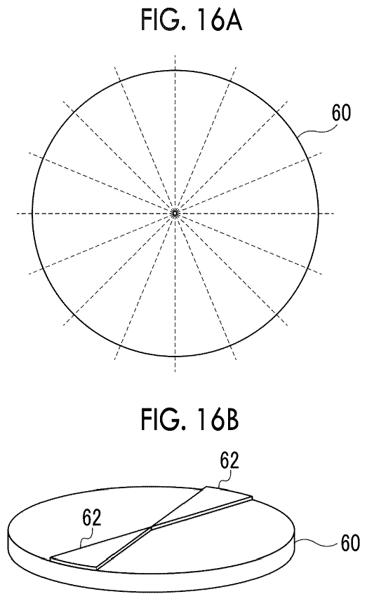

The concentration of the impurity elements was changed by adjusting the area of the optical glass piece or the carbon piece placed on the SiO₂ target. The thicknesses of the optical glass piece and the carbon piece were set to 1 mm. FIG. 16A is a schematic plan view showing a SiO₂ target 60 having a size of 6 inches. As shown in FIG. 16A, the area of the SiO₂ target 60 was divided into 16 equal parts, and the optical glass piece 62 or the carbon piece was placed on the SiO₂ target 60 so that the area thereof was 1/16, 2/16, . . . , and n/16 of the area of the SiO₂ target 60. FIG. 16B is a schematic view showing a state where two optical glass pieces 62 are placed on the SiO₂ target 60.

### (Sample Preparation Method)

As an optical substrate, a white board substrate having a diameter of 80 mm and a thickness of 2.5 mm was used, a silicon oxide film having a thickness of 1000 nm was formed on the white board substrate by a sputtering method, and an aluminum film having a thickness of 10 nm was further formed on the silicon oxide film by a sputtering method. During the formation of the silicon oxide film, as described above, a plurality of samples having different impurity concentrations were prepared by disposing the optical glass piece 62 or the carbon piece on the SiO₂ target 60. A hot water treatment was performed under the same conditions as in Test 1, and an etching treatment was performed under the same conditions as in Test 1. Finally, the uneven structure formed on the surface of the white board substrate as in the case of Test 1 was dip-coated with a fluorine coat (trade name: FLUOROSURF NL-1, manufactured by Fluoro Technology Corporation), thereby forming a water-repellent film.

B270i (manufactured by SCHOTT AG), H-ZF52 (manufactured by Chengdu Guangming Photoelectric Corp.), or S-LHA58 (manufactured by Ohara Corporation.) was used as the optical glass piece 62. B270i contains Al, H-ZF52 contains Ca, and S-LHA58 contains B. Table 8 lists the area ratio of the piece, the kind of optical glass, the concentration [wt %] of the impurity element, and the concentration of the impurity of each sample. For each sample, the composition analysis was performed by XPS after the formation of the silicon oxide film and before the etching to determine the impurity concentration.

### (Evaluation)

The state of etching was evaluated for each sample. The state of etching was evaluated based on the contact angle of water measured at the center portion of the substrate. This is because the water repellency is considered to be high in a case where the etching state is satisfactory. In the present example, the evaluation was performed according to the following evaluation standards.
A: The contact angle was 140° or greater.
B: The contact angle was 120° or greater and less than 140°.
C: The contact angle was less than 120°.

The evaluation results are listed in Table 8.

TABLE 8

| | B270i | | H-ZF52 | | S-LAH58 | | Carbon piece | |
|---|---|---|---|---|---|---|---|---|
| | Al | | Ca | | B | | C | |
| Area ratio of piece | Concentration | Etching | Concentration | Etching | Concentration | Etching | Concentration | Etching |
| 1/16 | 0.05 | A | 1.00 | A | 0.05 | A | 1.0 | A |
| 2/16 | 0.10 | A | 2.00 | B | 1.00 | A | 2.0 | A |
| 3/16 | 0.15 | B | 3.00 | C | 1.50 | B | 3.0 | A |
| 4/16 | 0.20 | B | 4.00 | C | 2.00 | B | 4.0 | A |
| 5/16 | 0.25 | B | 4.50 | C | 2.50 | C | 4.5 | B |
| 6/16 | 0.30 | C | 5.00 | C | 3.00 | C | 5.0 | B |
| 7/16 | 0.35 | C | 5.50 | C | 3.50 | C | 5.5 | B |
| 8/16 | 0.40 | C | 6.00 | C | 4.00 | C | 6.0 | B |
| 9/16 | 0.45 | C | 6.50 | C | 4.50 | C | 6.5 | C |
| 10/16 | 0.50 | C | 7.00 | C | 5.00 | C | 7.0 | C |

As listed in Table 8, in a case where the impurity contained in the silicon oxide film is aluminum, the content thereof is preferably 0.25 wt % or less and more preferably 0.10 wt % or less. In a case where the impurity contained in the silicon oxide film is calcium, the content thereof is preferably 2.00 wt % or less and more preferably 1.00 wt % or less. In a case where the impurity contained in the silicon oxide film is boron, the content thereof is preferably 2.00 wt % or less and more preferably 1.00 wt % or less. In a case where the impurity contained in the silicon oxide film is carbon, the content thereof is preferably 6.0 wt % or less and more preferably 4.0 wt % or less.

In a case where the fine uneven structure is directly formed on the surface of the optical substrate, as described above, the etching treatment may be inhibited due to the influence of the element that is bonded to fluorine contained in the optical substrate. Meanwhile, since the silicon oxide film is formed on the optical substrate by vapor phase film formation that enables suppression of impurities from being mixed, and a fine uneven structure is formed on the surface thereof, a problem in that the etching treatment is inhibited even in a case where the component contained in the optical substrate contains an element bonded to fluorine does not occur, and various optical substrates can be used regardless of the type of optical substrate.

### “Test 5”

In the sample preparation method of Test 1, a sample group in which the average height and the average period of the uneven structure were changed by changing the chemical etching conditions was prepared, and the reflectivity R, the haze H, and the water sliding properties were evaluated. The results are listed in Table 9.

TABLE 9

| | | Average height of unevenness [nm] | | | | | | | | | | | | | | |
|---|---|---|---|---|---|---|---|---|---|---|---|---|---|---|---|---|
| | | 100-150 | | | 150-200 | | | 200-250 | | | 250-300 | | | 300-350 | | |
| | | | | Sliding | | | Sliding | | | Sliding | | | Sliding | | | Sliding |
| | | Reflec- | | proper- | Reflec- | | proper- | Reflec- | | proper- | Reflec- | | proper- | Reflec- | | proper- |
| | | tivity | Haze | ties | tivity | Haze | ties | tivity | Haze | ties | tivity | Haze | ties | tivity | Haze | ties |
| Average | 100-150 | D | A | D | B | A | A | A | A | A | A | A | A | A | A | A |
| period | 150-200 | D | A | D | B | A | A | A | A | A | A | A | A | A | A | A |
| of un- | 200-250 | D | A | D | B | A | B | A | A | A | A | A | A | A | A | A |
| even- | 250-300 | D | A | D | B | A | B | A | A | A | A | A | A | A | A | A |
| ness | 300-350 | C | A | C | B | A | B | A | A | A | A | A | A | A | A | A |
| [nm] | 350-400 | C | A | C | B | B | C | A | B | A | A | B | A | A | B | A |
| | 400-450 | C | A | C | B | B | C | A | B | A | A | B | A | A | B | A |
| | | Average height of unevenness [nm] | | | | | | | | | | | | | | |
| | | 350-400 | | | 400-450 | | | 450-500 | | | 500-550 | | | 550-600 | | |
| | | | | Sliding | | | Sliding | | | Sliding | | | Sliding | | | Sliding |
| | | Reflec- | | proper- | Reflec- | | proper- | Reflec- | | proper- | Reflec- | | proper- | Reflec- | | proper- |
| | | tivity | Haze | ties | tivity | Haze | ties | tivity | Haze | ties | tivity | Haze | ties | tivity | Haze | ties |
| Average | 100-150 | A | B | A | A | B | A | A | B | A | A | B | A | A | B | A |
| period | 150-200 | A | B | A | A | B | A | A | B | A | A | C | A | A | C | A |
| of un- | 200-250 | A | B | A | A | B | A | A | B | A | A | C | B | A | C | B |
| even- | 250-300 | A | B | A | A | B | A | A | B | A | A | C | C | A | C | B |
| ness | 300-350 | A | B | A | A | B | A | A | C | A | A | C | C | A | C | C |
| [nm] | 350-400 | A | B | A | A | C | A | A | C | B | A | C | D | A | D | D |
| | 400-450 | A | C | A | A | C | B | A | C | B | A | D | D | A | D | D |

As shown in the results in Table 9, the average height and the average period of the unevenness can be in a range of 100 nm to 600 nm for the average height and a range of 100 nm to 450 nm for the average period by a combination of both the average height and the average period. The average height is preferably 150 nm to 600 nm, more preferably 150 nm to 450 nm, and particularly preferably 200 nm to 350 nm. In addition, the average period is preferably 150 nm to 450 nm, more preferably 150 nm to 400 nm, and particularly preferably 150 nm to 350 nm. In the combination, in a case where the average height is 100 nm to 150 nm, the average period is preferably 300 nm to 450 nm. In a case where the average height is 150 nm to 200 nm, the average period can be 100 nm to 450 nm, and is preferably 100 nm to 350 nm and more preferably 100 nm to 200 nm. In a case where the average height is 200 nm to 500 nm, the average period can be 100 nm to 450 nm, and is preferably 100 nm to 350 nm. The average height is particularly preferably 200 nm to 350 nm, and the average period is particularly preferably 100 nm to 350 nm. In a case where the average height is 500 nm to 600 nm, the average period is preferably 100 nm to 350 nm and more preferably 100 nm to 200 nm.

### “Test 6”

The present inventors have found that, in a case where a silicon oxide film having unevenness on a surface is formed on a flat plate-like optical substrate in the step of preparing the optical member according to the embodiment of the present disclosure, the quality of a transmission wavefront (contour interval) depends on the etching treatment conditions. In Test 6, the transmission wavefront aberration required for obtaining a satisfactory image was examined.

In the sample preparation method of Test 1, samples 6-1 to 6-4 were prepared by changing the time ratio between the etching time of the physical etching and the etching time of the chemical etching. Other conditions were the same as in the sample preparation method of Test 1, thereby preparing the samples 6-1 to 6-4. The physical etching time t1, the chemical etching time t2, and the etching time ratio (t1/t2)×100 of both the etching times of each of the samples 6-1 to 6-4 are listed in Table 10.

The transmission wavefront aberration, the image, and the water repellency function were evaluated for each sample, and the results thereof are listed in Table 10. The evaluation methods were as follows.

### (Method of Measuring Transmission Wavefront Aberration)

The transmission wavefront aberration was measured with a laser interferometer (F601, FUJIFILM Corporation). The measurement light was light having a wavelength λ of 633 nm. The measurement was performed by allowing measurement light to be incident on a surface of the optical member, which had an uneven structure. In Table 10, the PV value is also listed as the transmission wavefront aberration.

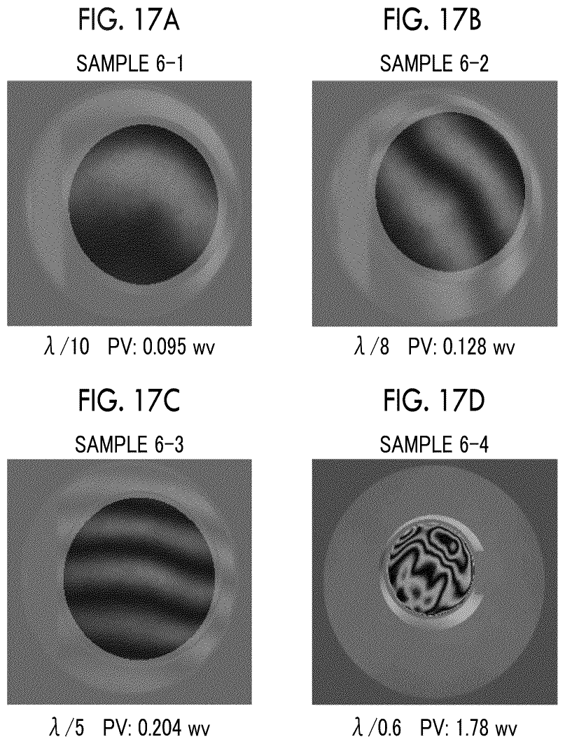

FIGS. 17A to 17D show surface images of the optical members in a case of measuring the transmission wavefront aberration for each of the samples 6-1 to 6-4. A portion indicated by a black circle at the center is the optical member.

### Image Evaluation Method

Each of the samples 6-1 to 6-4 was mounted on a general-purpose portable TV camera (main body: Sony HDC-4300, lens: Fujinon UA18×7.6BERD) as a lens filter, and an image of a subject was captured to display the captured image on a monitor. This captured image was subjected to sensory evaluation according to the following evaluation standards.

A: The subject could be clearly recognized.

B: The captured image was displayed, but the subject could not be identified.

C: The captured image could not be obtained.

### (Evaluation of Sliding Properties of Water)

The sliding properties of water were evaluated for the samples 6-1 to 6-4 by the same method as in Test 1.

TABLE 10

| Sample No. | 6-1 | 6-2 | 6-3 | 6-4 |
|---|---|---|---|---|
| Physical etching time t1 | 15 | 30 | 45 | 120 |
| [sec] | | | | |
| Chemical etching time t2 | 2700 | 2700 | 2700 | 2700 |
| [sec] | | | | |
| (t1/t2) × 100 | 0.56 | 1.11 | 1.67 | 4.44 |
| Transmission wavefront | λ/10 | λ/8 | λ/5 | λ/0.6 |
| aberration | | | | |
| Transmission wavefront | 0.095 | 0.128 | 0.204 | 1.76 |
| aberration PV | | | | |
| value [nm] | | | | |
| Image evaluation | A | A | A | B |
| Sliding properties of water | B | A | A | B |

As listed in Table 10, the transmission wavefront aberration is preferably λ/5 or less and more preferably λ/5 to λ/8.

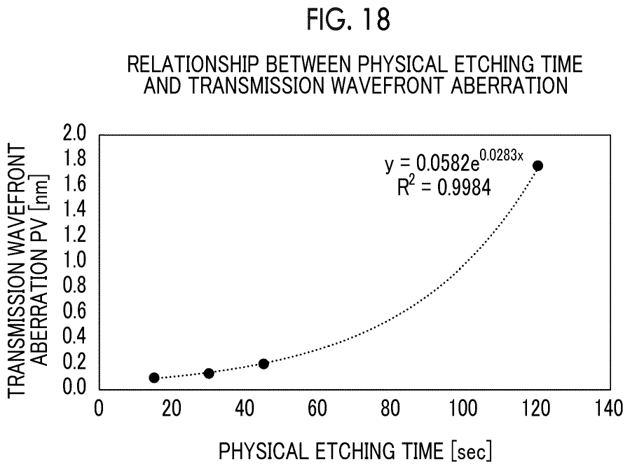

FIG. 18 shows the relationship between the physical etching time t1 and the wavefront aberration PV value. The broken line was a fitting curve y of 0.0582e^{0.0283x}, and the R² value was R² of 0.9984. As shown in FIG. 18, the wavefront aberration PV value tends to increase as the physical etching time t1 increases.

The sample 6-4, which had poor image evaluation results and poor sliding property evaluation results, was analyzed.

As SEM observation, an SEM observation sample before the physical etching treatment and after the chemical etching treatment was prepared by the same production method as that for the sample 6-4, and a cross-sectional SEM image was captured. As a result, a portion in which the lower layer of the silicon oxide film was partially etched by penetrating the recess portions of the mask (uneven structure layer consisting of an alumina hydrate) and a portion in which the uneven structure of the mask was destroyed and disappeared were present.

As elemental analysis, samples for analysis which had been subjected to a chemical etching treatment were prepared by the same preparation method as that for the samples 6-1 to 6-4, and the samples were subjected to the X-ray fluorescence analysis. As a result, the concentration (wt %) of Ar in the silicon oxide film of the sample 6-4 was about 15 times higher than that of the samples 6-1 to 6-3.

The transmission wavefront aberration is usually correlated with the deformation of the substrate. It is presumed that, in a case of physical etching using Ar, accelerated Ar is mixed into the silicon oxide film, and as a result, the Si—O—Si network of the SiO₂ film is distorted, the film stress of the SiO₂ film is increased, the substrate is deformed due to the high stress, and the transmission wavefront is deteriorated (the transmission wavefront aberration is increased).

As shown in the above-described analysis results and the relationship between the physical etching time t1 and the wavefront aberration PV value shown in FIGS. 17A to 17D, the physical etching time t1 is preferably 60 seconds or shorter and more preferably 45 seconds or shorter. Further, in order to improve the water repellency, it is preferable that the physical etching time t1 is set to 30 seconds or longer. The etching time ratio of the physical etching time t1 to the chemical etching time t2 (t1/t2)×100 is preferably 2.22 or less and more preferably 1.67 or less. The etching time ratio (t1/t2)×100 is particularly preferably 1.11 to 1.67.

### “Test 7”

As a constituent material of the water-repellent film, a fluorine compound that was particularly preferable from the viewpoint of durability was examined.

### (Sample Preparation Method)

The same sample preparation method as in Test 3 was used except that the etching treatment was performed with x=2 of SiOₓ of the silicon oxide film. In the step of forming the water-repellent film, samples 7-1 to 7-4 which were dip-coated with different fluorine compounds were prepared. A fluorine compound containing —(OCF₂CF₂)ₙ— (manufactured by Company A) as a functional group was used as the sample 7-1, a fluorine compound containing —(OCF₂CF₂)ₙ— (manufactured by Company B) as a functional group was used as the sample 7-2, a fluorine compound containing —(OCF₂)ₘ(OCF₂CF₂)ₙ— (manufactured by Company C) as a functional group was used as the sample 7-3, and a fluorine compound containing —(OCF₂) (OCF₂CF₂)ₙ— (manufactured by Company D) as a functional group was used as the sample 7-4.

Each sample was continuously irradiated with 150 W xenon lamp light (Super Bright 152S, manufactured by Kenko Tokina Co., Ltd.), and the contact angle of water was periodically measured. The xenon lamp light emission surface and the sample surface were disposed to face each other, and the distance between the two was set to 10 mm.

The number of days on which the contact angle was decreased by 3% and decreased by 5% from the initial value is summarized in Table 11. Further, N=4 samples were prepared for each type. The contact angle and the number of days in Table 11 are the averages of N=4.

TABLE 11

| | | | | Time at which | Time at which |
|---|---|---|---|---|---|
| | | | Contact | contact angle | contact angle |
| Sample | | | angle | was decreased | was decreased |
| No. | | Type of functional group | [deg.] | by 3% [days] | by 5% [days] |
| 7-1 | Company A | —(OCF₂CF₂)ₙ- | >150 | 100 | Not confirmed |
| 7-2 | Company B | —(OCF₂CF₂)ₙ- | >150 | 95 | Not confirmed |
| 7-3 | Company C | —(OCF₂)m(OCF₂CF₂)ₙ- | 145 | 70 | 150 |
| 7-4 | Company D | —(OCF₂)m(OCF₂CF₂)ₙ-- | 140 | 60 | 130 |

In Table 11, the expression “not confirmed” denotes that the 5% decrease in the contact angle was not observed even after 150 days. In the table, both n and m represent an integer of 1 or greater.

As listed in Table 11, in the samples 7-1 and 7-2 in which the fluorine compound contained a —(OCF₂CF₂)ₙ— group in which n represents an integer of 1 or greater and contained no —(OCF₂)ₘ— group in which m represents an integer of 1 or greater, the time taken for the contact angle to be decreased by 5% from the initial value was extremely long, and the durability was high.

### “Test 8”

The effect of providing an interlayer between the optical substrate and the silicon oxide film was verified.

### (Sample Preparation Method)

### ((Sample 8-1A))

A sample 8-1A was prepared as follows. As an optical substrate, a white board substrate (FDS90: manufactured by SCHOTT AG) having a diameter of 80 mm and a thickness of 2.5 mm was used. The refractive index n of FDS 90 with respect to light having a wavelength of 633 nm was 1.839. An interlayer was formed on the white board substrate by a sputtering method. Thereafter, a silicon oxide film with a thickness of 1000 nm was formed on the interlayer by a sputtering method, and an aluminum film with a thickness of 10 nm was further formed on the silicon oxide film by a sputtering method. Next, the white board substrate on which the silicon oxide film and the aluminum film were laminated was subjected to a hot water treatment of immersing the white substrate in hot water at 100° C. for 3 minutes. In this manner, the aluminum film was changed into a fine uneven layer consisting of an alumina hydrate. The film forming conditions for the silicon oxide film and the film forming conditions for the aluminum film were the same as the sample preparation method of Test 1.

Thereafter, an etching treatment was performed using the fine uneven layer as a mask. The etching treatment was performed under the same physical etching conditions and the same chemical etching conditions as those in the sample production method of Test 1 except that the chemical etching time was set to 45 minutes.

Further, a water-repellent film was formed on the uneven structure formed on the surface of the silicon oxide film by the same method as in Test 1.

The interlayer was a single-layer silicon oxynitride film (SiOₓN_{y}) having a refractive index of 1.515 with respect to light having a wavelength of 633 nm.

### ((Sample 8-1B))

A sample 8-1B having the same configuration as the configuration of the sample 8-1A except that the interlayer was not provided was prepared. The sample 8-1B was prepared by the same preparation method as that for the sample 8-1A except that the step of forming the interlayer was not provided and the silicon oxide film was directly formed on the surface of the white board substrate in the preparation method of the sample 8-1A.

### ((Sample 8-2A))

As an optical substrate, a white board substrate (H-ZLAF90: manufactured by SCHOTT AG) having a diameter of 80 mm and a thickness of 2.5 mm was used. The H-ZLAF90 has a refractive index n of 1.9928 with respect to light having a wavelength of 633 nm. As an interlayer, a multilayer film having a five-layer structure formed by alternately laminating a dielectric film having a low refractive index and a dielectric film having a high refractive index was formed. A sample 8-2A was prepared by the same preparation method as that for the sample 8-1A except that the type of the optical substrate was changed, the interlayer was changed to a multilayer film, and the chemical etching time was set to 30 minutes.

As the interlayer, a silicon oxynitride film (SiOₓN_{y}) was used as a dielectric film having a low refractive index, and niobium oxide (Nb₂O₅₋ₓ) was used as a dielectric film having a high refractive index. The refractive index and the film thickness of each film were as listed in Table 12. In Table 12, the interlayers are shown such that the first layer is on the side closest to the silicon oxide film and the fifth layer is on the side closest to the substrate.

TABLE 12

| | | Composition | Refractive | Thickness |
|---|---|---|---|---|
| | | of film | index | [nm] |
| Interlayer | 1 | SiOₓN_{y} | 1.515 | 111 |
| | 2 | Nb₂O₅₋ₓ | 2.38 | 10 |
| | 3 | SiOₓN_{y} | 1.515 | 51 |
| | 4 | Nb₂O₅₋ₓ | 2.38 | 20 |
| | 5 | SiOₓN_{y} | 1.515 | 19 |

| | | |
|---|---|---|
| Substrate | H-ZLAF90 | 2.024 |

### ((Sample 8-2B))

A sample 8-2B having the same configuration as the configuration of the sample 8-2A except that the interlayer was not provided was prepared. The sample 8-2B was prepared by the same preparation method as that for the sample 8-2A except that the step of forming the interlayer was not provided and the silicon oxide film was directly formed on the surface of the white board substrate in the preparation method of the sample 8-2A.

### ((Sample 8-3A))

As an optical substrate, a white board substrate (BaFD7: manufactured by SCHOTT AG) having a diameter of 80 mm and a thickness of 2.5 mm was used. The BaFD7 has a refractive index n of 1.698 with respect to light having a wavelength of 633 nm. As an interlayer, a multilayer film having a three-layer structure formed by alternately laminating a dielectric film having a low refractive index and a dielectric film having a high refractive index was formed. A sample 8-3A was prepared by the same preparation method as that for the sample 8-1A except that the type of the optical substrate was changed, the interlayer was changed to a multilayer film, and the chemical etching time was set to 50 minutes.

As the interlayer, a silicon oxynitride film (SiOₓN_{y}) was used as a dielectric film having a low refractive index, and niobium oxide (Nb₂O₅-x) was used as a dielectric film having a high refractive index. The refractive index and the film thickness of each film were as listed in Table 13. In Table 13, the interlayers are shown such that the first layer is on the side closest to the silicon oxide film and the third layer is on the side closest to the substrate.

TABLE 13

| | | Composition | Refractive | Thickness |
|---|---|---|---|---|
| | | of film | index | [nm] |
| Interlayer | 1 | SiOₓN_{y} | 1.51 | 89 |
| | 2 | Nb₂O₅₋ₓ | 2.351 | 6 |
| | 3 | SiOₓN_{y} | 1.51 | 36 |

| | | |
|---|---|---|
| Substrate | BaFD7 | 1.706 |

### ((Sample 8-3B))

A sample 8-3B having the same configuration as the configuration of the sample 8-3A except that the interlayer was not provided was prepared. The sample 8-3B was prepared by the same preparation method as that of the sample 8-3A except that the step of forming the interlayer was not included in the preparation method of the sample 8-3A and the silicon oxide film was directly formed on the surface of the white board substrate.

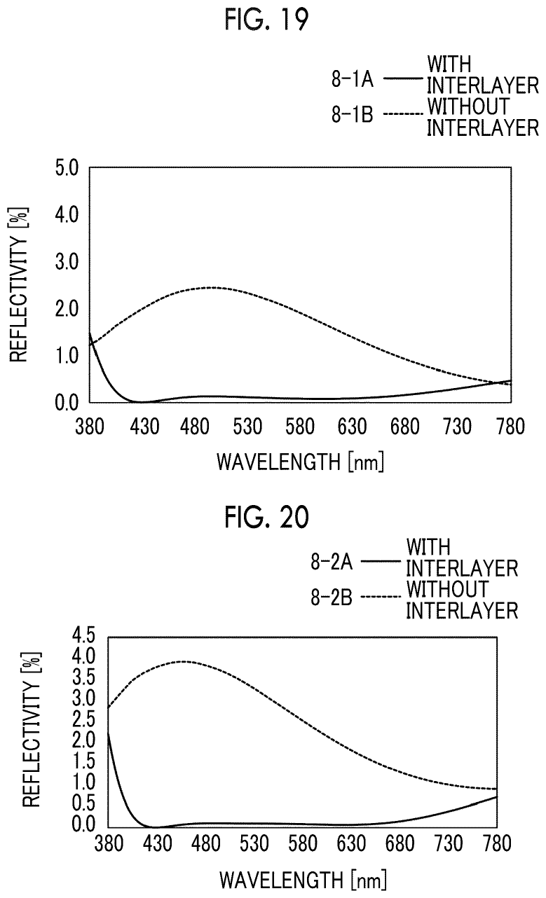

FIG. 19 shows the results of measuring the wavelength dependence of the reflectivity of the samples 8-1A and 8-1B. In FIG. 19, the solid line indicates the wavelength dependence of the reflectivity of the sample 8-1A having an interlayer, and the broken line indicates the wavelength dependence of the reflectivity of the sample 8-1B not having an interlayer.

The average reflectivity in a wavelength range of 400 nm to 700 nm was 0.1% for the sample 8-1A and 1.83% for the sample 8-1B. It is considered that, in the sample 8-1A, a difference in refractive index between the respective layers could be decreased and the reflectivity could be reduced, by providing the interlayer having a refractive index between the refractive index of the optical substrate and the refractive index (n=1.46) of the silicon oxide film.

FIG. 20 shows the results of measuring the wavelength dependence of the reflectivity of the samples 8-2A and 8-2B. In FIG. 20, the solid line indicates the wavelength dependence of the reflectivity of the sample 8-2A having an interlayer, and the broken line indicates the wavelength dependence of the reflectivity of the sample 8-2B not having an interlayer.

The average reflectivity in a wavelength range of 400 nm to 700 nm was 0.1% for the sample 8-2A and 2.8% for the sample 8-2B. It is considered that the sample 8-2A comprised an interlayer consisting of a multilayer film between the optical substrate and the silicon oxide film, and as a result, the reflectivity could be reduced due to the effect of interference between reflected light generated at the boundary of each film due to the interlayer.

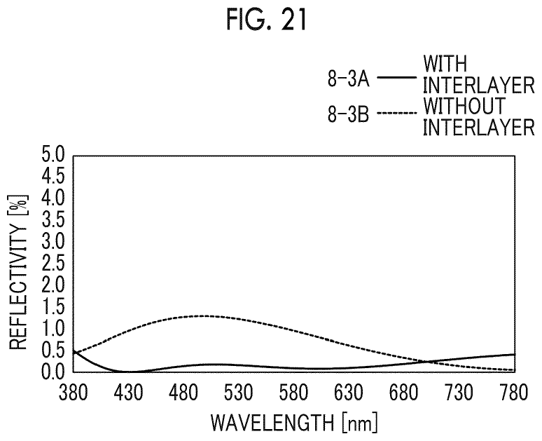

FIG. 21 shows the results of measuring the wavelength dependence of the reflectivity of the samples 8-3A and 8-3B. In FIG. 21, the solid line indicates the wavelength dependence of the reflectivity of the sample 8-3A having an interlayer, and the broken line indicates the wavelength dependence of the reflectivity of the sample 8-3B not having an interlayer.

The average reflectivity in a wavelength range of 400 nm to 700 nm was 0.1% for the sample 8-3A and 2.8% for the sample 8-3B. It is considered that the sample 8-3A comprised an interlayer consisting of a multilayer film between the optical substrate and the silicon oxide film, and as a result, the reflectivity could be reduced due to the effect of interference between reflected light generated at the boundary of each film due to the interlayer.

It was clarified by Test 8 that in a case where the sample comprised an interlayer, the sample had an effect of significantly reducing the reflectivity.

In regard to the above-described embodiment, the following supplementary notes will be further disclosed.

### (Additional Note 1)

An optical member comprising:
an optical substrate having a smooth surface; and
a silicon oxide film provided on the optical substrate,
in which the silicon oxide film has a fine uneven structure on a surface thereof,
the optical member includes a water-repellent film containing a fluorine compound on the surface of the fine uneven structure, and
a surface of the water-repellent film has an adhesion energy of 0.2 mN/m to 6 mN/m.

### (Additional Note 2)

The optical member according to Additional note 1,
in which the fluorine compound contains a —(OCF₂CF₂)ₙ— group, where n represents an integer of 1 or greater and contains no —(OCF₂)ₘ— group, where m represents an integer of 1 or greater.

### (Additional Note 3)

The optical member according to Additional note 1 or 2, in which a sliding angle of a 5 μL water droplet on the surface of the water-repellent film is 10° or less.

### (Additional Note 4)

The optical member according to any one of Additional notes 1 to 3,
in which in the silicon oxide film, a content of aluminum is 0.25 wt % or less, a content of calcium is 2.0 wt % or less, a content of boron is 2.0 wt % or less, and a content of carbon is 6.0 wt % or less.

### (Additional Note 5)

The optical member according to any one of Additional notes 1 to 4,
in which the silicon oxide film is a sputtered film or a vapor deposition film.

### (Additional Note 6)

The optical member according to any one of Additional notes 1 to 5,
in which in a case where a composition of a silicon oxide contained in the silicon oxide film is represented by SiOₓ, 1.90≤x≤2.00 is satisfied.

### (Additional Note 7)

The optical member according to any one of Additional notes 1 to 6,
in which the fine uneven structure has an average height from a bottom of a recess portion of the fine uneven structure to an apex of a protrusion portion of 150 nm to 600 nm and an average period of 150 nm to 450 nm.

### (Additional Note 8)

The optical member according to any one of Additional notes 1 to 7,
in which a contact angle of water on the surface of the water-repellent film is 140° or greater.

### (Additional Note 9)

The optical member according to any one of Additional notes 1 to 8,
in which a haze is 2.5% or less.

### (Additional Note 10)

The optical member according to any one of Additional notes 1 to 9,
in which an average reflectivity in a case where light having a wavelength of 400 nm to 700 nm is perpendicularly incident on the surface is 1% or less.

### (Additional Note 11)

The optical member according to any one of Additional notes 1 to 10, in which a transmission wavefront aberration with respect to light having a wavelength of A nm is 25 or less.

### (Additional Note 12)

The optical member according to any one of Additional notes 1 to 11, further comprising:
an interlayer having a refractive index different from a refractive index of the silicon oxide film for reducing a reflectivity with respect to incident light, between the optical substrate and the silicon oxide film.

### (Additional Note 13)

A method of producing an optical member, comprising:
a film forming step of forming a silicon oxide film on one surface of an optical substrate by a vapor phase film forming method;
a mask forming step of forming an etching mask on the silicon oxide film;
an etching step of etching the silicon oxide film by a vapor phase etching method through the etching mask to form a fine uneven structure on a surface of the silicon oxide film; and
a coating step of forming a water-repellent film containing a fluorine compound on a surface of the fine uneven structure,
in which in the etching step, etching is performed until a distance from a surface of the silicon oxide film on an optical substrate side to an apex of a maximum protrusion portion of the fine uneven structure is less than a film thickness of the silicon oxide film immediately after the film formation.

The disclosure of Japanese Patent Application No. 2023-054253 filed on Mar. 29, 2023 is incorporated in the present specification by reference. All of the documents, the patent applications, and the technical standards described in the present specification are incorporated into the present specification by reference to the same extent as in a case in which each of the documents, the patent applications, and the technical standards are specifically and individually stated to be described by reference.

What is claimed is:

1. An optical member comprising:
an optical substrate having a smooth surface; and
a silicon oxide film provided on the optical substrate,
wherein the silicon oxide film has a fine uneven structure on a surface thereof,
the optical member includes a water-repellent film containing a fluorine compound on the surface of the fine uneven structure, and
a surface of the water-repellent film has an adhesion energy of 0.2 mN/m to 6 mN/m.

2. The optical member according to claim 1,
wherein the fluorine compound contains a —(OCF₂CF₂)ₙ— group, where n represents an integer of 1 or greater and contains no —(OCF₂)ₘ— group, where m represents an integer of 1 or greater.

3. The optical member according to claim 1,
wherein a sliding angle of a 5 μL water droplet on the surface of the water-repellent film is 10° or less.

4. The optical member according to claim 1,
wherein in the silicon oxide film, a content of aluminum is 0.25 wt % or less, a content of calcium is 2.0 wt % or less, a content of boron is 2.0 wt % or less, and a content of carbon is 6.0 wt % or less.

5. The optical member according to claim 1,
wherein the silicon oxide film is a sputtered film or a vapor deposition film.

6. The optical member according to claim 1,
wherein in a case where a composition of a silicon oxide contained in the silicon oxide film is represented by SiOₓ, 1.90≤x≤2.00 is satisfied.

7. The optical member according to claim 1,
wherein the fine uneven structure has an average height from a bottom of a recess portion of the fine uneven structure to an apex of a protrusion portion of 150 nm to 600 nm and an average period of 150 nm to 450 nm.

8. The optical member according to claim 1,
wherein a contact angle of water on the surface of the water-repellent film is 140° or greater.

9. The optical member according to claim 1,
wherein a haze is 2.5% or less.

10. The optical member according to claim 1,
wherein an average reflectivity in a case where light having a wavelength of 400 nm to 700 nm is perpendicularly incident on the surface is 1% or less.

11. The optical member according to claim 1,
wherein a transmission wavefront aberration with respect to light having a wavelength of λ nm is λ/25 or less.

12. The optical member according to claim 1, further comprising:
an interlayer having a refractive index different from a refractive index of the silicon oxide film for reducing a reflectivity with respect to incident light, between the optical substrate and the silicon oxide film.

13. A method of producing an optical member, comprising:
a film forming step of forming a silicon oxide film on one surface of an optical substrate by a vapor phase film forming method;
a mask forming step of forming an etching mask on the silicon oxide film;
an etching step of etching the silicon oxide film by a vapor phase etching method through the etching mask to form a fine uneven structure on a surface of the silicon oxide film; and
a coating step of forming a water-repellent film containing a fluorine compound on a surface of the fine uneven structure,
wherein in the etching step, etching is performed until a distance from a surface of the silicon oxide film on an optical substrate side to an apex of a maximum protrusion portion of the fine uneven structure is less than a film thickness of the silicon oxide film immediately after the film formation.
